(19) United States
(12) Patent Application Publication
(10) Pub. No.: US 2024/0383173 A1
(43) Pub. Date: Nov. 21, 2024

(54) CONCRETE SAWBLADE WITH CUTTERS AND CUTTER POCKETS

(71) Applicant: Evolution Drilling Tools, Inc., Quanah, TX (US)

(72) Inventors: Jason Palmer, Huntsville, UT (US); Ronnie Keys, Quanah, TX (US)

(73) Assignee: Evolution Drilling Tools, Inc., Quanah, TX (US)

(21) Appl. No.: 18/614,431

(22) Filed: Mar. 22, 2024

Related U.S. Application Data
(63) Continuation-in-part of application No. 18/299,617, filed on Apr. 12, 2023.

(51) Int. Cl. B28D 1/12

(52) U.S. Cl. CPC B28D 1/122

(57) ABSTRACT

Blades and methods of manufacturing the same. A blade includes a blade body and a cutting edge disposed around a perimeter of the blade body, wherein the cutting edge comprises a centerline and a width. The blade includes a plurality of cutter pockets attached to the blade body such that two or more of the plurality of cutter pockets are attached to the blade body at a different position across the width of the cutting edge relative to the centerline of the cutting edge.

### CROSS-REFERENCE TO RELATED APPLICATIONS

This application is a continuation-in-part of U.S. patent application Ser. No. 18/299,617, filed Apr. 12, 2023, entitled “CONCRETE SAW BLADE WITH CUTTERS AND CUTTER POCKETS,” which is incorporated herein by reference in its entirety, including but not limited to those portions that specifically appear hereinafter, the incorporation by reference being made with the following exception: In the event that any portion of the above-referenced application is inconsistent with this application, this application supersedes the above-referenced application.

### TECHNICAL FIELD

This application is directed to cutting and trenching tools and is particularly directed to blades and cutters.

### BACKGROUND

Concrete sawblades (may be referred to as road saws or consaws) are typically selected for cutting concrete, bricks, asphalt, and other solid substrates. Several types of concrete sawblades exist in the market that are selected based on the type of substrate to be cut, the depth of the cut, and the purpose of the cut. Traditional concrete sawblades are manufactured using impregnated diamond grit, which typically includes a lab-created diamond grit embedded within a binder material. The impregnated diamond grit is typically joined directly to a blade body, welded, or otherwise affixed to the blade.

Diamond grit is hard and sharp enough to grind concrete and asphalt. However, diamond grit cuts slowly and is not durable. Due to this mechanism of grinding through concrete as the diamond grit wears, the concrete sawblade becomes dull and must then be discarded or repaired. Smaller concrete blades, e.g., those for handheld saws, are typically discarded, while larger blades, e.g., those used for large walk-behind or ride-on machinery, can at times be repaired due to cost.

Concrete sawblades may be implemented as circular rotary blades, such as those used with circular saws, concrete and asphalt cutters, concrete cutting saws, asphalt cutting machines, and so forth. Additionally, impregnated diamond like that used on concrete sawblades may be implemented with other geometrical configurations, such as the hollow cylindrical geometry used for core barrels. Regardless of the configuration, it is desirable to improve the cutting speed and durability of traditional concrete sawblades.

In view of the foregoing, disclosed herein are improved systems, methods, and devices for concrete and asphalt blades.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. Advantages of the disclosure will become better understood with regard to the following description and accompanying drawings where:

FIG. 1 illustrates a straight-on view of a side of a blade comprising a plurality of cutters and cutter pockets;

FIG. 2 is a perspective view of a blade comprising a plurality of cutters and cutter pockets;

FIG. 3 is a straight-on view of a side of a portion of a blade comprising a plurality of cutters and cutter pockets;

FIG. 4 is a perspective view of a portion of a blade comprising a plurality of cutters and cutter pockets;

FIG. 5 is a perspective view of a portion of a cutting edge of a blade comprising a plurality of cutters and cutter pockets;

FIG. 6 is a perspective view of a portion of a cutting edge of a blade comprising a plurality of cutters and cutter pockets;

FIG. 7 is a perspective view of a portion of a cutting edge of a blade comprising a plurality of cutters and cutter pockets;

FIG. 8 is a perspective view of a portion of a blade comprising a plurality of cutters and cutter pockets;

FIG. 9 is a perspective view of a portion of a blade comprising a plurality of cutters and cutter pockets, and specifically illustrates a cutter affixed to a cutter pocket that is affixed to a cutting edge of the blade;

FIG. 10 is a perspective view of a portion of a blade comprising a plurality of cutters and cutter pockets;

FIG. 11 is a schematic illustration of a cutting profile for a traditional blade;

FIG. 12 is a schematic illustration of a progressive cutting profile for a blade as described herein;

FIG. 13 is a schematic illustration of a cross-sectional geometry of a cutter;

FIG. 14 is a schematic illustration of a cross-sectional geometry of a cutter pocket corresponding with the cutter illustrated in FIG. 13;

FIG. 15 is a schematic illustration of a cross-sectional geometry of a cutter;

FIG. 16 is a schematic illustration of a cross-sectional geometry of a cutter pocket corresponding with the cutter illustrated in FIG. 15;

FIG. 17A is a schematic illustration of a cutting diagram for manufacturing eight cutters from a single cylindrical cutter;

FIG. 17B is a schematic illustration of a cutting diagram for manufacturing six cutters from a single cylindrical cutter;

FIG. 18 is a schematic illustration of a cutter against a formation depicting a back rake angle of the cutter;

FIG. 19A is a straight-on view of a traditional blade configured to grind rather than cut a substrate material;

FIG. 19B is a perspective view of a portion of a traditional blade configured to grind rather than cut a substrate material;

FIG. 19C is a straight-on view of a portion of a traditional blade configured to grind rather than cut a substrate material;

FIG. 20 illustrates a straight-on view of a side of a blade comprising a plurality of cutters and cutter pockets;

FIG. 21 is a perspective view of a blade comprising a plurality of cutters and cutter pockets;

FIG. 22 is a perspective view of a portion of a blade comprising a plurality of cutters and cutter pockets;

FIG. 23 is a straight-on view of a portion of a side of a blade comprising a plurality of cutters and cutter pockets;

FIG. 24 is a perspective view of a cutter disposed within a cutter pocket of a blade;

FIG. 25 is a straight-on view of a cutter disposed within a cutter pocket of a blade;

FIG. 26 is a schematic illustration of a cutter failing a substrate;

FIG. 27 is a schematic illustration of a cutter failing a substrate;

FIG. 28 is a schematic illustration of a cutting profile for a traditional blade;

FIG. 29 is a schematic illustration of a progressive cutting profile for a blade as described herein;

FIG. 30A is a perspective view of a core barrel blade comprising a plurality of cutters and cutter pockets;

FIG. 30B is an aerial top-down view of a core barrel blade comprising a plurality of cutters and cutter pockets;

FIG. 30C is a straight-on side view of a core barrel blade comprising a plurality of cutters and cutter pockets;

FIG. 31 is a perspective view of a core barrel blade comprising a plurality of cutter pockets;

FIG. 32A is a perspective view of a core barrel blade comprising a plurality of cutters and cutter pockets;

FIG. 32B is a perspective view of a core barrel blade comprising a plurality of cutters and cutter pockets; and

FIG. 33 is a cross-sectional straight-on side view of a portion of a core barrel blade comprising a plurality of cutters and cutter pockets.

### DETAILED DESCRIPTION

Disclosed herein are systems, methods, and devices for improved blades, and specifically for improved concrete sawblades that can be implemented for cutting hard substrates such as concrete, brick, asphalt, rock, tile, and so forth. The blades described herein include ultrahard cutters manufactured with polycrystalline diamond compact (PDC) or a similarly hard material. The blades described herein exhibit increased durability when compared with traditional concrete blades, and in some cases have shown to be at least 40 times more durable than traditional concrete blades. Further, the blades described herein cut significantly faster than traditional concrete blades, and in some cases will cut three to five times faster than traditional blades.

The blades described herein are configured to cut a substrate like concrete, brick, asphalt, rock, tile, and so forth. This is a departure from traditional concrete sawblades, which are specifically designed to grind, rather than cut, the substrate. Traditional concrete sawblades typically include a plurality of blade segments that are embedded with abrasive materials like diamond grit. The blade segments are designed to wear away, and the continuous wear of the blade segments exposes new diamond grit that grinds against the substrate. Traditional concrete sawblades naturally wear down quickly because they are designed to continually expose new, sharp diamond grit to grind the substrate. The improved concrete sawblades described herein are designed to cut the substrate and are proven to cut faster and last longer than traditional concrete sawblades.

A blade described herein includes a blade body, a cutter pocket configured to receive and hold a cutter, and a cutter attached to the cutter pocket. The blade body may be constructed of a singular piece of a hard material such as steel. In some implementation, the cutter pocket is an integral component of the blade body such that the blade body and the cutter pockets form a single element, and in other implementations, the cutter pockets are constructed separately from the blade body and then affixed to a cutting edge of the blade body by way of welding or brazing. The cutter is manufactured from an ultrahard material such as PDC. The cutter may be removably affixed to the cutter pocket or permanently affixed to the cutter pocket by way of welding or brazing. The dimensions, configurations, and cross-sectional geometry of the cutter and cutter pocket are optimized for efficiently cutting through hard materials such as concrete, asphalt, brick, rock, and so forth.

Depending on the implementation, the cutters described herein may include a cross-sectional geometry comprising a “pie slice” or circular sector geometry or may alternatively include an elliptical cross-sectional geometry. In implementations utilizing the pie slice geometry, these cutters may be manufactured by first manufacturing a cylindrical cutter comprising a circular cross-sectional geometry. The cylindrical cutter is cut down to multiple cutters each comprising the circular sector cross-sectional geometry. The dimensions of the cutters are optimized based on the desired width of the cut. In many implementations, it is desirable to make the narrowest cut into the substrate possible, and in these cases, it is important to ensure that the greatest width of the cross-sectional geometry of the cutter does not exceed the desired width of the substrate cut. The cutter layouts described herein enable increased control over the width of the cut. In traditional systems, it is challenging to manufacture a blade with a precise cut width that can cut through hard materials like concrete and asphalt.

The cross-sectional geometry of the cutter pocket is optimized to securely receive the cutter. Thus, in some implementations, the cutter pocket comprises a cross-sectional geometry configured to receive the apex or point of a cutter comprising the circular sector geometry. In other implementations, the cutter pocket comprises a rounded geometry configured to receive a portion of the cylindrical shape of a cutter comprising the elliptical/circular cross-sectional geometry. The cross-sectional geometries of the cutter and the cutter pocket will correspond with one another and may be adjusted and optimized depending on the intended use-case and the desired width of the substrate cut.

The blades described herein exhibit significantly improved performance and durability when compared with traditional concrete and asphalt blades. The cutters and cutter pockets described herein increase the durability of the blade and the speed with which the blade can cut through a hard substrate such as concrete, asphalt, rock, brick, and so forth. The blades described herein may be implemented as circular blades intended for concrete cutting or asphalt cutting applications, wherein a narrow blade (e.g., from about 1.5 mm to about 5 mm blade width) is preferred. Additionally, the blades described herein may be implemented as circular blades intended for microtrenching applications, wherein a wider blade (e.g., from about 20 mm to about 100 mm) is preferred. Additionally, the same “cutter segments” used to manufacture the blades described herein may be implemented on hollow cylindrical tubes or barrels to be applied as a “core barrel” for cutting a circular core into a substrate.

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the systems, methods, and devices for an improved blade are disclosed and described, it is to be understood that this disclosure is not limited to the particular structures, configurations, process steps, and materials disclosed herein as such structures, configurations, process steps, and materials may vary somewhat. It is also to be understood that the terminology employed herein is used for the purpose of describing particular embodiments only and is not intended to be limiting because the scope of the disclosure will be limited only by the appended claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element or step not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

As used herein, the terms “ellipse” and “elliptical” refer to a plane curve surrounding two focal points, such that for all points on the curve, the sum of the two distances to the focal points is a constant. As described herein, an ellipse or elliptical geometry shall include a circle or circular geometry.

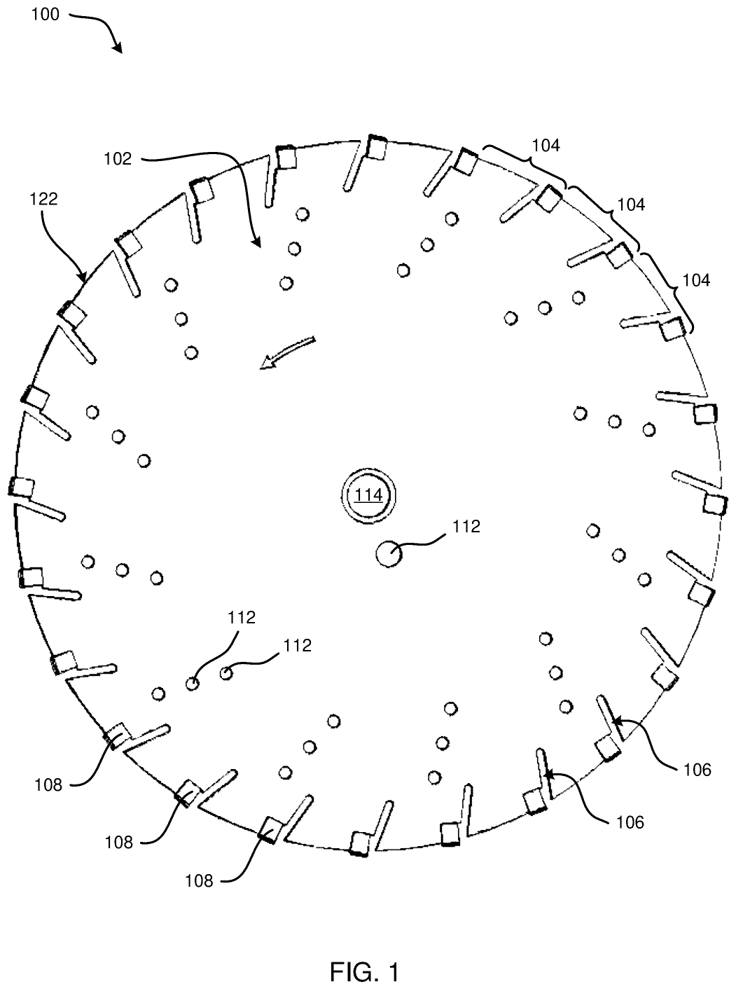

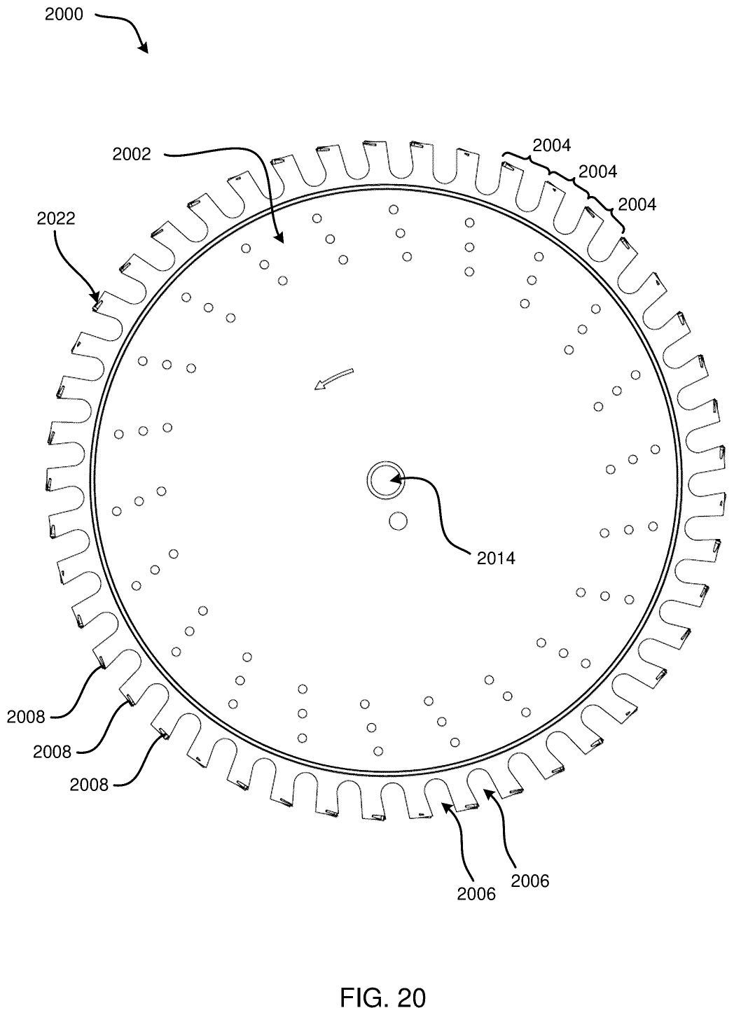

Now referring to the figures, FIGS. 1-16 and 17A-17B illustrate various views and components of a blade equipped with a plurality of cutters. The embodiments illustrated in FIGS. 1-16 and 17A-17B include cutters having a “pie slice” or circular segment cross-sectional geometry. FIGS. 20-29 similarly illustrate various views and components of a blade equipped with a plurality of cutters. The embodiments illustrated in FIGS. 20-29 include cutters having an elliptical/circular cross-sectional geometry. The cross-sectional cutter geometries described herein may be implemented in any blade embodiment described herein. In some cases, a single blade may include varying cutter geometries, and may specifically include some cutters having the circular segment cross-sectional geometry and may additionally have other cutters having the elliptical/circular cross-sectional geometry.

FIG. 1 is a primary straight-on view of a side of a blade 100. The blade 100 includes a blade body 102, which typically includes a flat disc portion as shown in FIG. 1. In an alternative embodiment, the components of the blade 100 are implemented to form a core barrel, and in this case, the blade body 102 will form a hollow cylinder comprising a circular cross-sectional geometry.

The blade 100 includes a cutting edge 122 extending around the perimeter of the blade. The cutting edge 122 of the blade includes the exterior-most portions of the blade body 102, along with components of cutter pockets 108 and cutters 110. The cutting edge 122 of the blade 100 includes portions of the blade that contact and cut through the substrate material during operation. The blade 100 may specifically be designed to cut hard materials such as concrete, asphalt, brick, or rock. The width of the cutting edge 122 will be optimized depending on the intended use-case. In some cases, the cutting edge 122 comprises a narrow width for making a narrow cut into a hard substrate, and in these implementations, the blade is manufactured with a blade width from about 1.5 mm to about 10 mm. In other implementations, the cutting edge 122 comprises a wider width that is desirable in other applications, and the width may specifically be from about 10 mm to about 100 mm.

The blade 100 includes a plurality of cutting elements 104. Each cutting element 104 includes a gullet 106, a cutter pocket 108, and a cutter 110 (not shown in FIG. 1). The blade 100 additionally includes a center arbor bore 114 and a plurality of periphery bores 112. The center arbor bore 114 and the plurality of periphery bores 112 represent cutouts within the blade body 102. The center arbor bore 114 is configured to receive a corresponding cylinder on cutting equipment for stabilizing and rotating the blade. In the implementation depicted in FIG. 1, the blade rotates about an axis of rotation that is perpendicular to the center arbor bore 114 (such that the blade 100 spins counterclockwise about an axis of rotation that goes into and out of the page in the illustration in FIG. 1). The periphery bores 112 are implemented to decrease the overall weight of the blade 100, and to allow the blade to slightly flex or bend so as not to permanently bend or break. This decreases the work that must be performed by the cutting equipment when rotating the blade, and further increases user experience when transporting and exchanging the blades 100.

The blade body 102 is constructed of a rigid material and may specifically be constructed of steel. The blade body 102 may be constructed of, for example, medium carbon steel, low-alloy manganese, or high carbon steel. The blade 100 is configured to successfully cut and excavate through dirt, rocks, concrete, asphalt, and other materials.

The blade body 102 may be constructed of a single piece of material. In some embodiments, the blade 100 further includes a “blade cap”, which includes the cutter pockets 108 and the cutters 110 (not shown in FIG. 1) disposed around the cutting edge 122 of the blade 100. Thus, some components of each of the cutting elements 104 may be manufactured independently of the blade body 102 and then welded, brazed, or otherwise affixed to the blade body 102. In an embodiment, the width of the cutting edge 122 of the blade 100 is greater than a thickness of the blade body 102 of the blade 100.

In some implementations, the blade body 102 and the plurality of cutter pockets 108 are manufactured together as a single indivisible element constructed of the same material. In these implementations, the blade body 102 and the plurality of cutter pockets 108 may each be manufactured of one or more of carbon steel, stainless steel, tool steel, alloy steel, cobalt, or titanium alloy.

The gullets 106 are machined into the blade body 102. The depths of the gullets 106, measured from the cutting edge 122 of the blade 100 to an interior-most position of the gullets 106, is optimized depending on the implementation and the intended substrate to be cut.

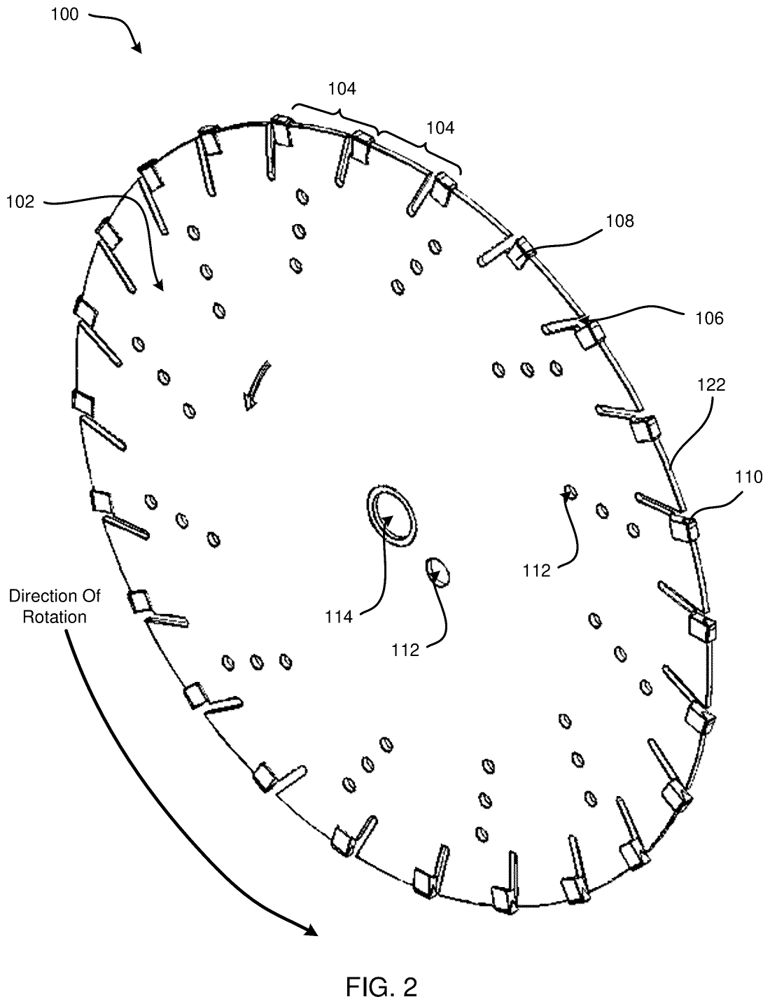

FIG. 2 is a perspective view of the blade 100 that illustrates a portion of the cutting edge 122 and width of the blade 100. Some of the cutters 110 secured to the cutter pockets 108 are visible in the perspective shown in FIG. 2.

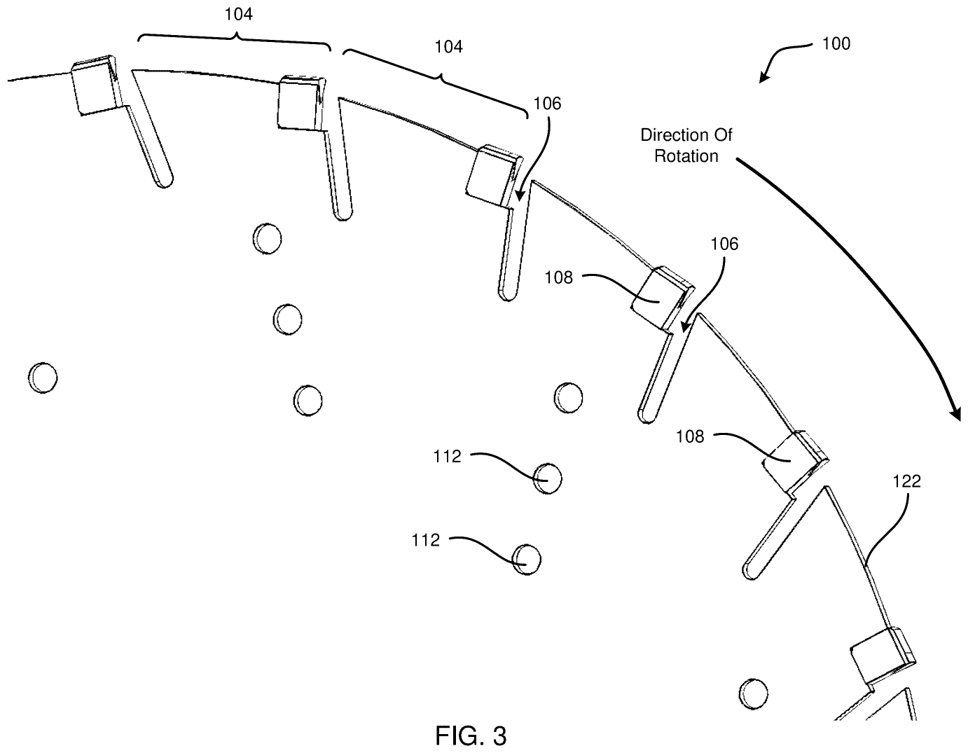

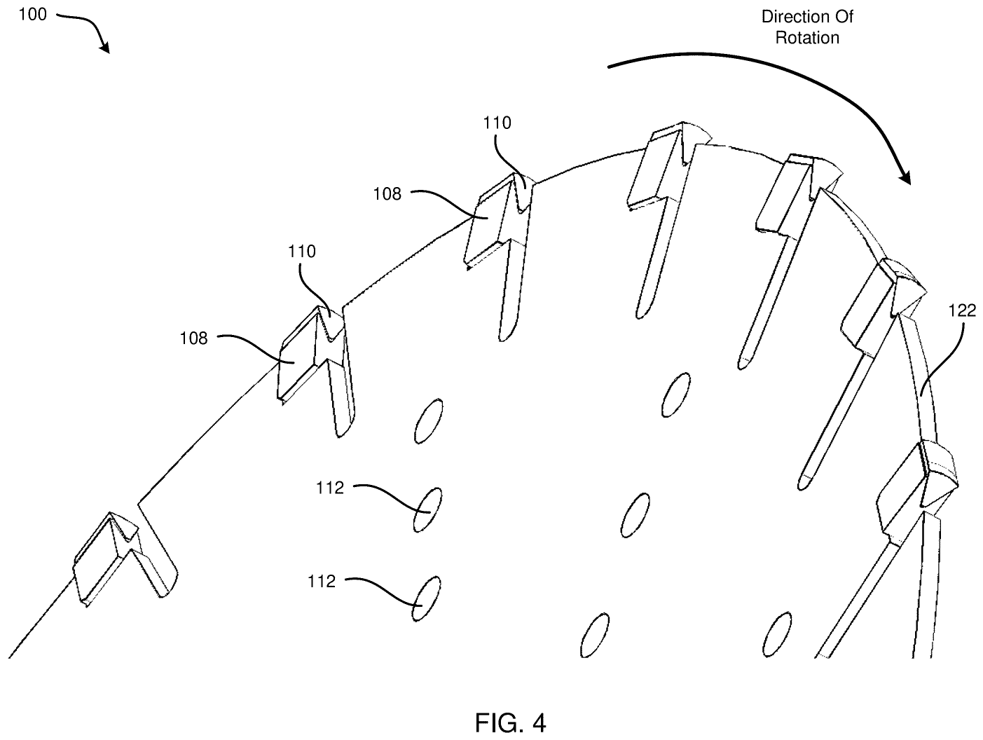

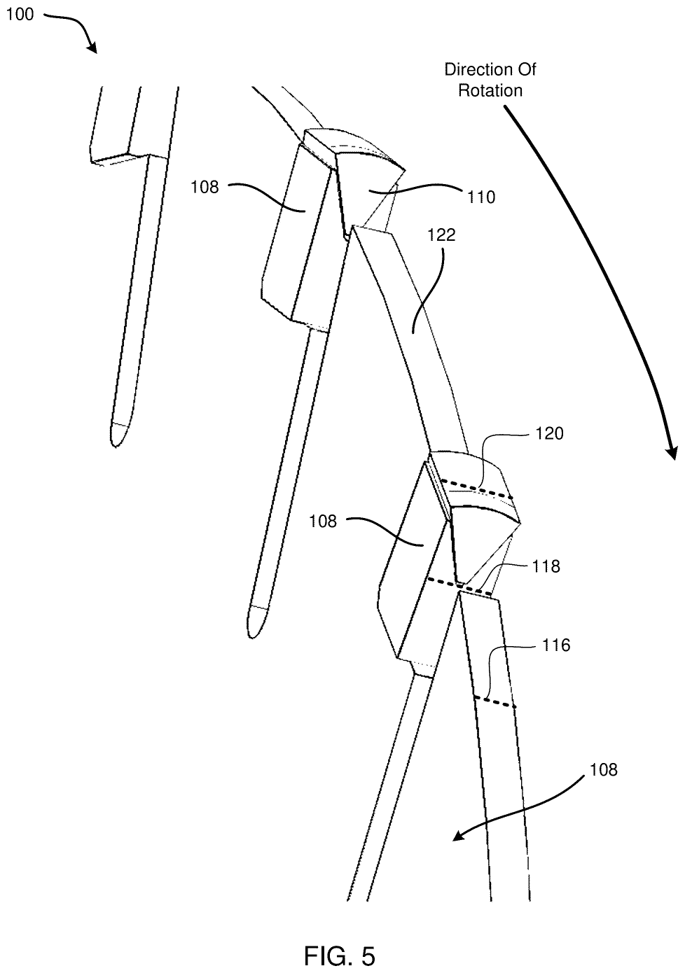

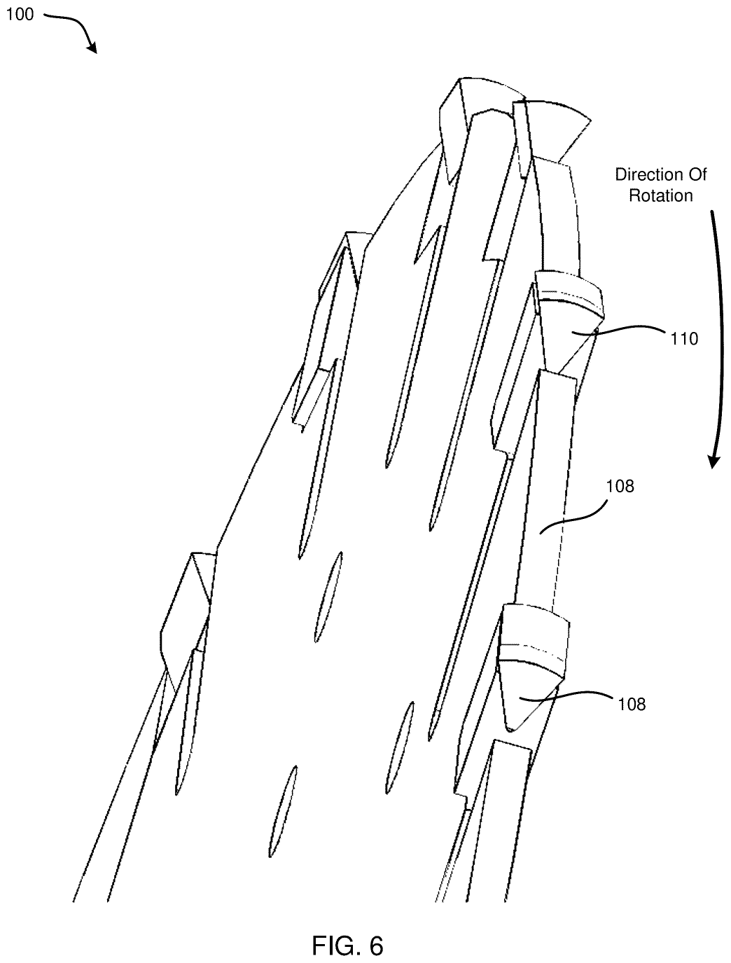

FIGS. 3-6 illustrate various views of a portion of a cutting edge 122 of the blade 100. FIG. 3 is a straight-on view of a portion of the blade 100, FIG. 4 is a perspective view of a portion of the blade 100, FIG. 5 is a perspective view of a portion of the blade 100, and FIG. 6 is a perspective view of a portion of the blade 100.

In implementations wherein the blade 100 is optimized for cutting a hard material such as concrete, asphalt, rock, or brick, each cutting element 104 includes one cutter pocket 108 with one cutter 110 disposed within the cutter pocket 108. In this implementation, the blade 100 includes a 1:1 ratio of cutters 110 to gullets 106. In alternative implementations, a single cutting element 104 may include multiple cutter pockets 108 and cutters 110, such that the blade 100 does not have a 1:1 ratio of cutters 110 to gullets 106.

The gullets 106 are cut into the blade body 102 at an angle that is offset from a radial line (wherein the radial line extends from the center point of the blade body 102 to the perimeter and is perpendicular to the perimeter of the blade body 102). The offset angle of the gullet 106 increases the effectiveness of the gullet 106 and enables the gullet to successfully excavate a greater quantity of substrate material.

The cutter pockets 108 are designed to accept and securely hold a cutter. The cutter 110 may be permanently welded or brazed into the cutter pocket 108, and then the cutter pocket 108 (with the cuter 110 affixed therein) is welded or brazed to the blade body 102. The cutter pockets 108 are constructed of a hard material such as carbide.

The cutters 110 described herein are sufficiently hard and durable for cutting hard substrates such as concrete, asphalt, brick, or rock. The hardness and durability of the cutter 110 is optimized and selected based on manufacturing cost and intended application. The cutters 110 described herein may be constructed of, for example, polycrystalline diamond compact (PDC), tungsten carbide, silicon carbide, cemented carbide, steel, titanium carbide, tungsten, boron carbide, diamond, and so forth. The cutters may be constructed of a material comprising a hardness equal to or exceeding the hardness of polycrystalline diamond compact (PDC).

The cutters 110 may specifically be constructed of a superhard material with a hardness value exceeding 40 gigapascals when measured by the Vickers hardness test. The cutters 110 may be constructed of a material with a hardness value from about 60-150 gigapascals when measured by the Vickers hardness test. The Vickers hardness test was developed by Robert L. Smith and George E. Sandland to measure the hardness of materials. The Vickers hardness test measures the material's ability to resist plastic deformation from a standard source. The unit of hardness given by the test is known as the Vickers Pyramid Number (HV) or Diamond Pyramid Hardness (DPH) and can be converted to SI units (gigapascals). The cutters 110 may be constructed of a material with a hardness of at least 7 on the Mohs hardness scale and may specifically be constructed of a material with a hardness of at least 8.5 on the Mohs hardness scale.

The cutters 110 are manufactured independently of the blade body 102 and the cutter pockets 108. In some implementations, each cutter 110 is permanently affixed to a cutter pocket 108, and then the cutter pocket 108 is affixed to the blade body 102. Typically, the cutters 110 are brazed to the cutter pockets 108 such that the cutters 110 are not easily removable. However, it should be understood that the cutters 110 could be removed by melting the braze with heat. In the case of a large diameter blade, it might be beneficial to remove the cutters 110 due to wear and then replace the removed cutters 110 with new cutters 110. This can easily be done with any of these blades.

The cutters 110 are arranged such that each cutter performs a portion of the work when cutting rock, concrete, asphalt, brick, or other hard substrate materials. The cutters 110 may specifically be referred to as “shearing cutters” because they are configured to shear off small pieces of material when the blade 100 is in use. The progressive cutter layout described herein ensures that each cutter 110 takes a small “bite” into the substrate such that the workload is distributed across a plurality of cutters 110 that each occupy a different space within the overall progressive layout. This improves the cutting efficiency and longevity of the blade.

The dimensions of the cutters 110 are optimized based on the type of material that will be sheared and excavated during the cutting operation. Typically, the desired width of the substrate cut (i.e., the width of the cut made into the substrate) will guide the maximum width of the cutters 110. In some cases, it is desirable to make a narrow substrate cut, and in these cases, the maximum width of the cutters 110 may be from about 1.5 mm to about 10 mm.

The cutters are orientated with a back rake angle (the back rake angle is illustrated in FIG. 18). Two or more of the cutters 110 may have a different back rake angle. In an embodiment, the back rake angles of the cutters 110 vary within a defined range that is optimized based on the type of material that is being sheared and excavated. In an embodiment, the back rake angles of the cutters 110 range from 0 degrees to 20 degrees and may specifically range from 5 degrees to 15 degrees. The blade 100 may include one, two, three, or more different back rake angles across the plurality of cutters 110 disposed within the blade. The blade 100 is more efficient and demonstrates greater durability when the cutters 110 are installed with varying back rake angles to equally distribute the work of shearing material during the microtrenching operation.

As shown in FIG. 5, the cutting edge 122 of the blade body 102 includes a blade body width 116, which is measured from a first side of the blade body 102 to a second side of the blade body 102. The cutter pocket 108 includes a cutter pocket width 118 measured from one side of the cutter pocket 108 to the other side as shown in FIG. 5. The cutter 110 includes a maximum cutter width 120 measured along its greatest width as shown in FIG. 5.

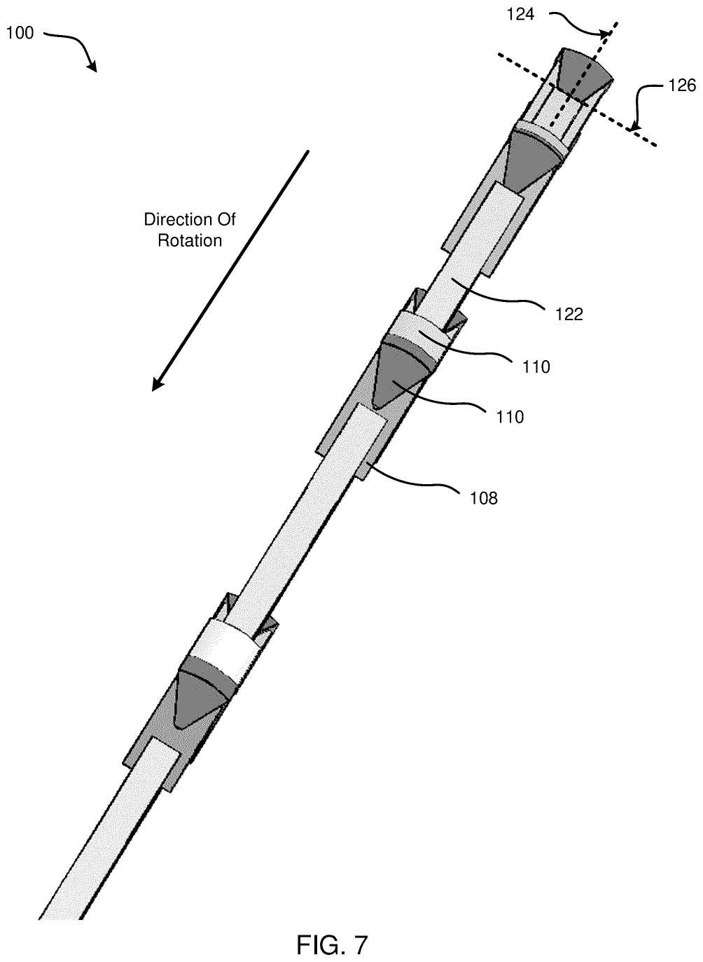

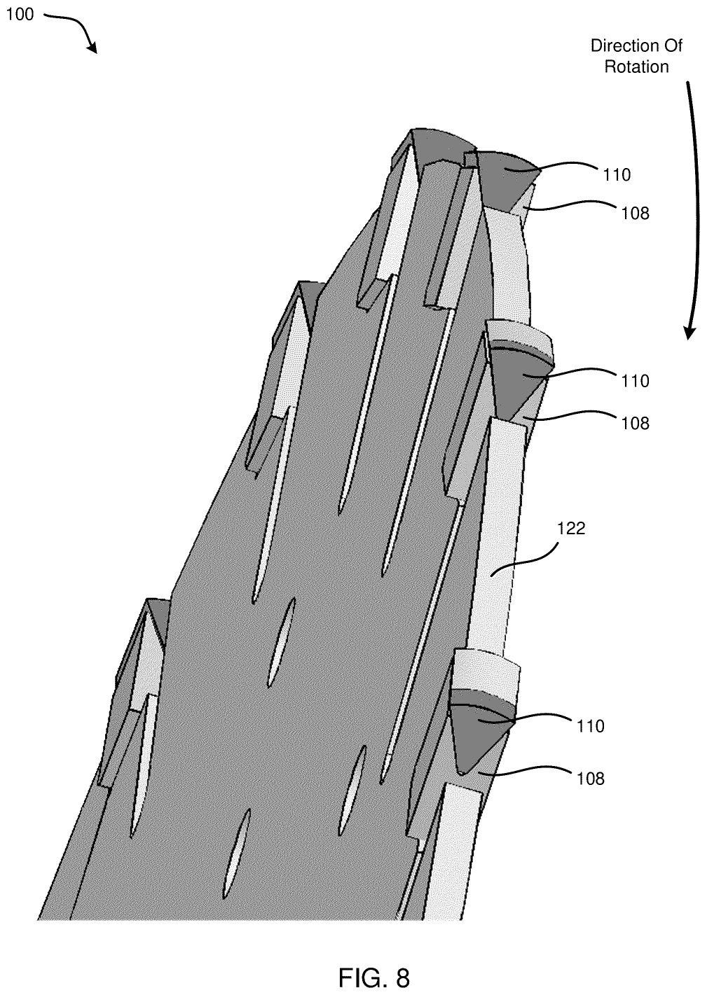

FIGS. 7 and 8 illustrate views of the cutting edge 122 of the blade 100, wherein FIG. 7 is a straight-on view of a portion of the cutting edge 122, and FIG. 8 is a perspective view of the blade 100 showing a portion of the cutting edge 122. The view in FIG. 7 illustrates that the cutter 110 has a circular sector geometry (may alternatively be referred to as a disk sector geometry). The cutter 110 is affixed to the cutter pocket 108, which in turn is affixed to the cutting edge 122 of the blade body 102.

As shown in FIG. 7, the cutting edge 122 of the blade 100 includes a centerline 124 that is perpendicular to the width axis 126 of the cutting edge 122. The centerline 124 runs around the perimeter of the cutting edge 122. In an implementation as shown in FIG. 7, the cutters 110 are positioned on the cutting edge 122 of the blade 100 such that the point or apex of the circular sector cross-sectional geometry of the cutter 110 aligns with the centerline 124.

The orientations of the cutters 110 relative to the centerline 124 may be optimized and adjusted to distribute the work more evenly across the multiple cutters 110. This is shown in FIG. 12, wherein the cutters 110 are distributed with two or more different cutting orientations relative to the centerline 124. The cutting orientations of the cutters 110 may be optimized to ensure the cutters 110 perform equal work when the blade 100 is in use. The location, orientation, and rake angles of the cutters 110 are altered and optimized depending on the type of material that is being sheared and excavated.

In some implementations, one or more of the cutters 110 are positioned on the cutting edge 122 of the blade 100 such that a portion of the cutters 110 are on a first side of the width 126, and another portion of the cutters are on a second side of the width 126 relative to the centerline 124. The cutters 110 may alternate such that neighboring cutters are on opposite sides of the width of the cutting edge 122.

In an embodiment, the cutters 110 are offset relative to one another along the cutting edge 122 of the blade 100. The blade body width 116 includes a first side and a second side separated by the centerline 124, wherein the second side is opposite the first side. In an embodiment, a first cutter is located near the first side of the width, a second cutter is located near the second side of the width, a third cutter is located near the first side of the width, a fourth cutter is located near the second side of the width, a fifth cutter is located near the first side of the width, a sixth cutter is located near the second side of the width, and so on. In this embodiment, the cutters 110 alternate sides of the cutting edge 122 around the perimeter of the blade 100.

The cutters 110 are separately and independently manufactured components that are installed into the cutting edge 122 of the blade 100. In various embodiments, the blade body 102 is constructed of steel, and the cutter pockets 108 and the cutters 110 are constructed of polycrystalline diamond compact, diamond, or carbide, and the cutter pockets 108 are installed into the cutting edge 122 of the blade 100. In other embodiments, the blade body 102 and the cutter pockets 108 are both manufactured from steel as a single indivisible element, and then the cutters 110 are installed into the cutter pockets 108 . . . . The cutters 110 may be replaced to extend the life of the blade 100 or to optimize the blade 100 for different types of material. For example, in some implementations, a carbide cutter may be more effective than a polycrystalline diamond compact cutter, and vice versa, and in these cases, it may be beneficial to have the capability of swapping the cutters 110.

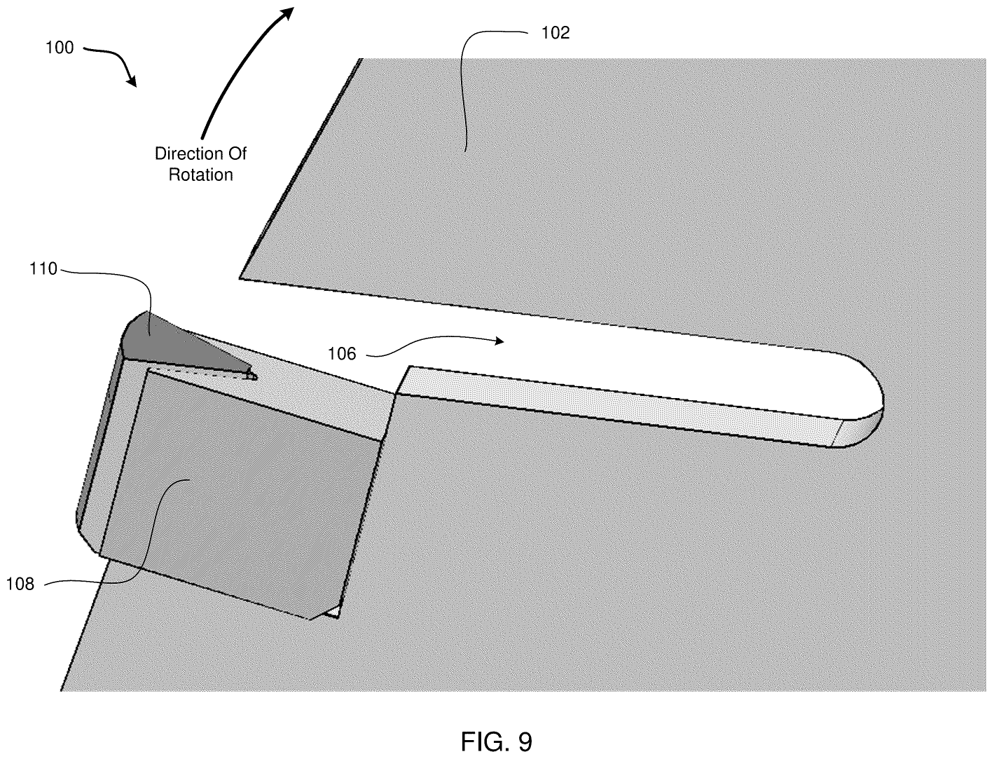

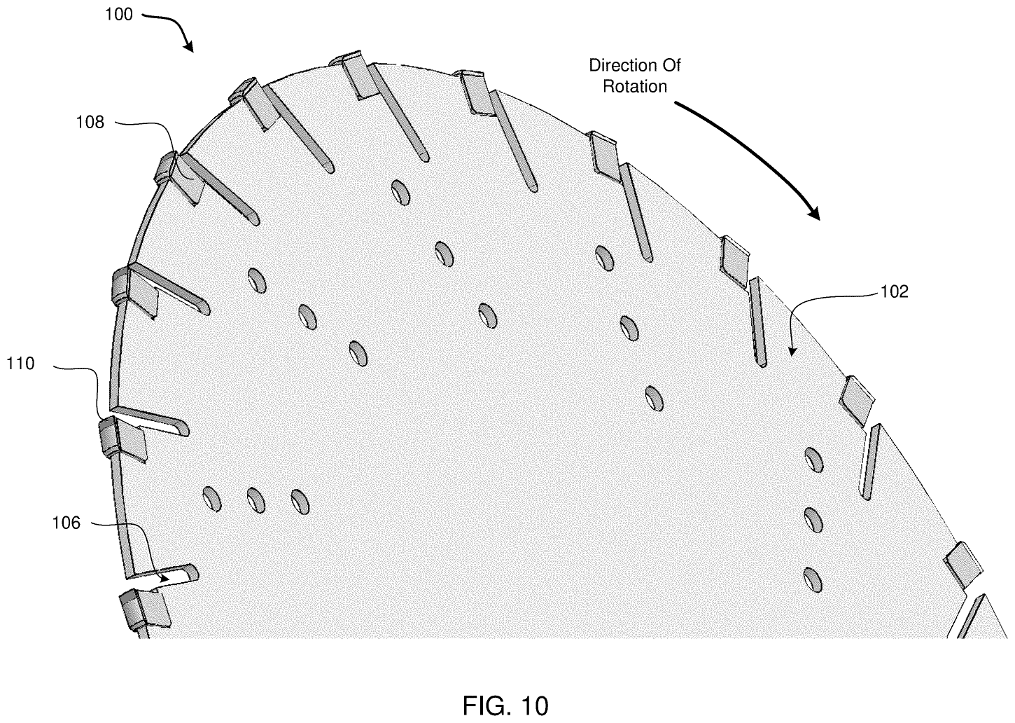

FIGS. 9 and 10 illustrate perspective views of portions of the blade 100. FIG. 9 illustrates a zoomed-in nearly straight-on view of the blade and specifically depicts a singular cutter pocket 108, singular cutter 110, and singular gullet 106. FIG. 10 illustrates a perspective view of the blade 100 with the blade rotating such that a back side of the cutter pockets 108 is seen.

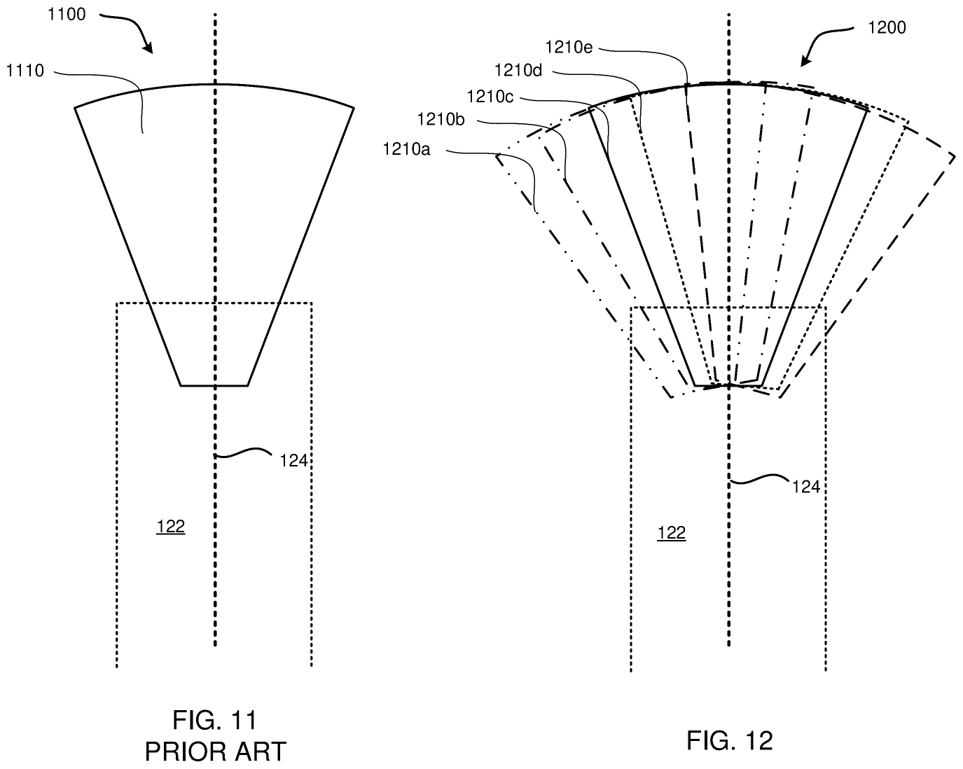

FIG. 11 is a schematic illustration of a cutting profile 1100 for a concrete blade. The cutting profile illustrates the cutting orientation 1110 of the cutters 110 relative to the cutting edge 122 of the blade. In the configuration illustrated in FIG. 11, all cutters 110 have the same cutting orientation 1110 relative to the centerline 124 of the cutting edge 122.

FIG. 12 is a schematic diagram of a progressive cutting profile 1200 for a blade 100 as described herein. The example cutting profile depicted in FIG. 12 includes five different cutting orientations 1210a, 1210b, 1210c, 1210d, 1210e, although a blade may have more cutting orientations. The cutting orientations 1210a-1210e illustrated in FIG. 12 represent the angles of attack and offset locations of the cutters 110 along the cutting edge 122 of the blade 100. In the implementation illustrated in FIG. 12, the cutters 110 are arranged with five different cutting orientations 1210a-1210e to distribute work across the cutters 110 and dramatically increase the longevity and durability of the cutters 110. The quantity of cutting orientations 1210a-1210e distributed around the blade 100 will be optimized depending on a number of factors, including the intended use of the blade the dimensions of the blade and the cutters.

The cutting profiles 1210a-1210e illustrate where the material (such as rock, concrete, dirt, asphalt, and so forth) is attacked and sheared during operation. The varying cutting profiles 1210a-1210e enable the blade 100 to cut the substrate material at different locations during operation. The varying cutting profiles 1210a-1210e further ensure the cutters 110 each perform a small portion of the work during operation. The offset cutter orientations described herein increase the effectiveness and durability of the blade 100.

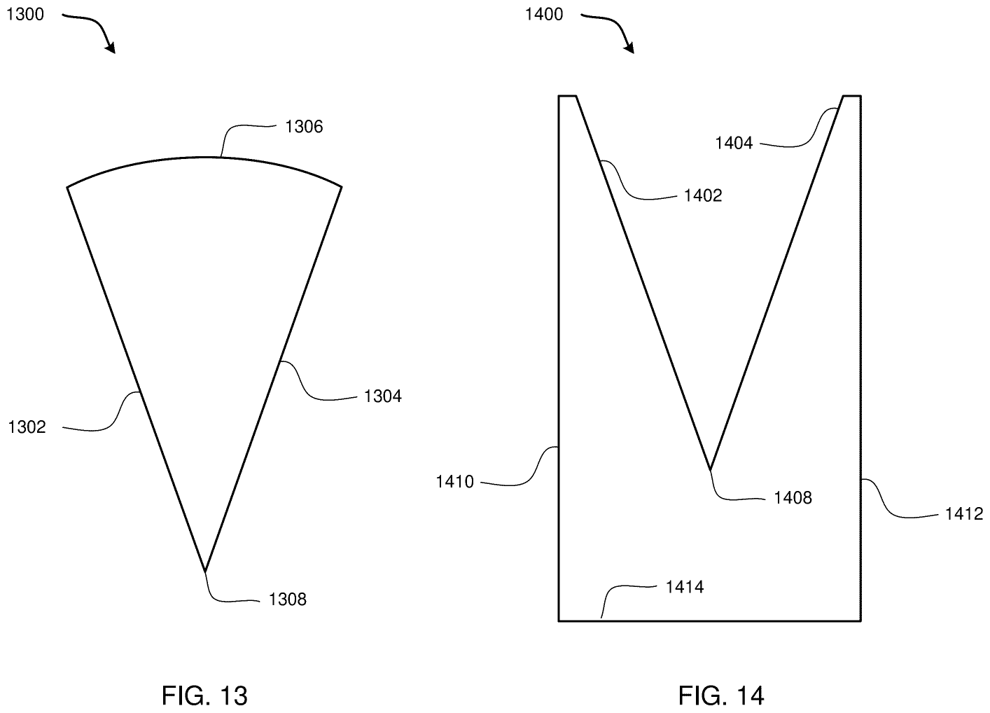

FIGS. 13 and 14 are schematic drawings depicting example cross-sectional geometries 1300, 1400 of a cutter 110 (see FIG. 13) and a cutter pocket 108 (see FIG. 14). As discussed herein, the cutter pocket 108 may be manufactured separately from the blade body 102 and then welded or blazed on to the blade body 102. In other implementations, the cutter pocket 108 and the blade body 102 are manufactured of the same material as a single indivisible element.

The cutter cross-sectional geometry 1300 depicted in FIG. 13 is a circular sector, which includes a portion of a disk (a closed region bounded by a circle) enclosed by two radii 1302, 1304 and an arc 1306. The two radii 1302, 1304 meet at an apex 1308 or point. The cutter cross-sectional geometry 1300 may be referred to as having an irregular triangular geometry due to its three sides. The cutter 108 can colloquially be referred to as having a pie slice cross sectional geometry 1300.

The cutter pocket cross-sectional geometry 1400 is configured to receive the corresponding cutter cross-sectional geometry 1300. Thus, the cutter pocket cross-sectional geometry 1400 includes an apex 1408 configured to receive the apex 1308 of the cutter. The cutter pocket cross-sectional geometry 1400 further includes a first side 1402 and a second side 1404 configured for receiving the radii 1302, 1304 sides of the cutter. The cutter pocket cross-sectional geometry 1400 may additionally include three or more exterior sides 1410, 1412, 1414 that provide additional stability and enable the cutter pocket to be affixed to the cutting edge of the blade. The cutter pocket cross-sectional geometry 1400 may be referred to as having an irregular pentagonal geometry due to its five sides 1402, 1404, 1410, 1412, 1414.

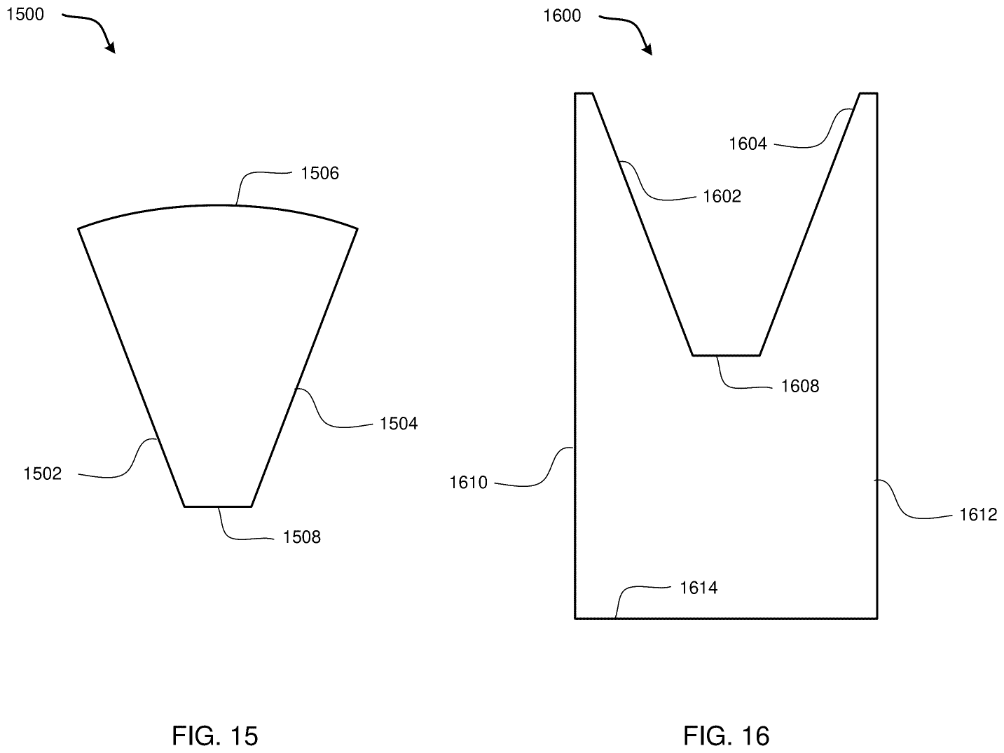

FIGS. 15 and 16 are schematic drawings depicting example cross-sectional geometries 1500, 1600 of a cutter 110 (see FIG. 15) and a cutter pocket 108 (see FIG. 16). The cutter cross-sectional geometry 1500 depicted in FIG. 15 is a modified circular sector, which includes a portion of a disk (a closed region bounded by a circle) enclosed by two radii 1502, 1504, an arc 1506, and an opposite side 1508 (wherein the opposite side 1508 is opposite the arc 1506). The two radii 1302, 1304 meet at an apex 1308 or point. The cutter cross-sectional geometry 1300 may be referred to as having an irregular quadrilateral geometry due to its four sides.

The cutter pocket cross-sectional geometry 1600 is configured to receive the corresponding cutter cross-sectional geometry 1500. Thus, the cutter pocket cross-sectional geometry 1600 includes a side 1608 configured to receive the opposite side 1508 of the cutter. The cutter pocket cross-sectional geometry 1600 further includes a first side 1602 and a second side 1604 configured for receiving the radii 1502, 1504 sides of the cutter. The cutter pocket cross-sectional geometry 1600 may additionally include three or more exterior sides 1610, 1612, 1614 that provide additional stability and enable the cutter pocket to be affixed to the cutting edge of the blade. The cutter pocket cross-sectional geometry 1600 may be referred to as having an irregular hexagonal geometry due to its six sides 1602, 1604, 1608, 1610, 1612, 1614.

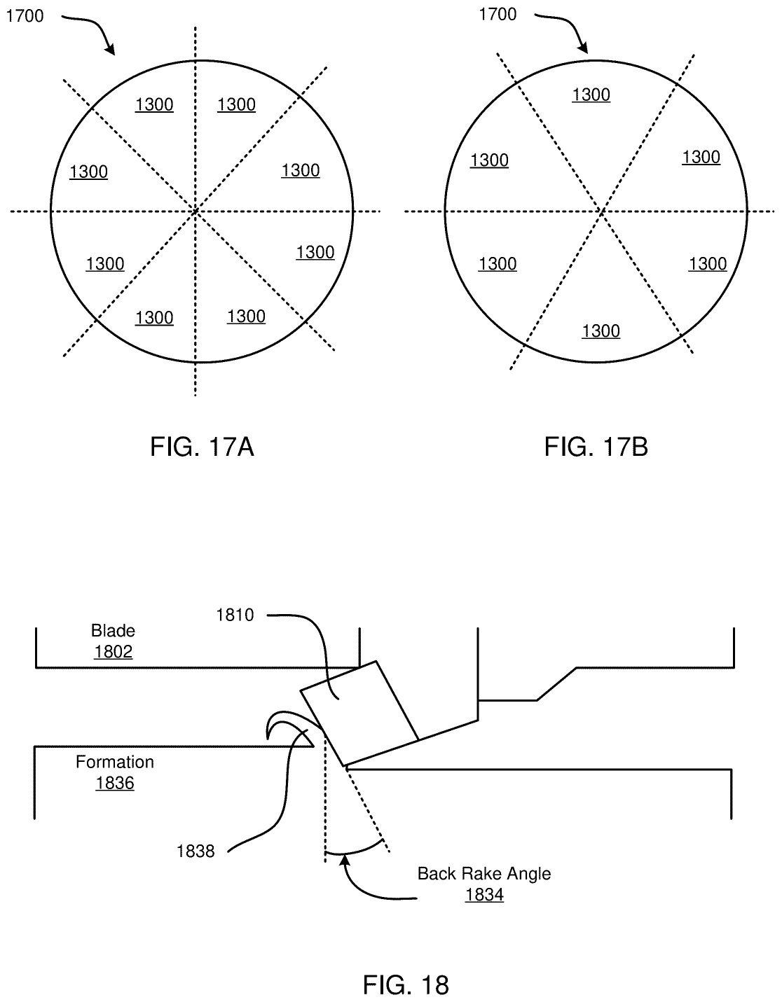

FIGS. 17A and 17B are schematic illustrations depicting example means of manufacturing a plurality of cutters 110. The cutters 110 described herein may have a pie sliced cross-sectional geometry as shown in FIG. 13, or a modified pie sliced cross-sectional geometry as shown in FIG. 15. Cutters 110 having these cross-sectional geometries are efficiently manufactured by cutting a cylindrical cutter 1700 into a plurality of cutters 110 each having the pie sliced cross-sectional geometry or a modified pie sliced cross-sectional geometry.

In the example depicted in FIG. 17A, the cylindrical cutter 1700 is cut into eight equal cutters 110 each comprising the circular sector cross-sectional geometry 1300 depicted in FIG. 13. In the example depicted in FIG. 17B, the cylindrical cutter 1700 is cut into six equal pieces each comprising the circular sector cross-sectional geometry 1300 depicted in FIG. 13.

Standard cylindrical cutters 1700 (like those which might be used in microtrenching blades) are typically too large to use in concrete cutting applications, wherein the blade width is typically from about 1.5 mm to about 10 mm. The cylindrical cutter 1700 is cut into smaller pieces using electrical discharge machining (EDM) or another suitable means. The equivalent triangular pieces may then be welded or brazed into a carbide cutter pocket, which may in turn to be welded or brazed on to the sawblade.

Thus, a method of manufacturing the cutters 110 described herein includes preparing a cylindrical cutter 1700 comprising a cylindrical cross-sectional geometry and a length/height suitable for a cutter 110. The method includes cutting the cylindrical cutter 1700 into a plurality of cutter 110 portions each having a circular sector cross-sectional geometry as shown in FIGS. 17A-17B.

FIG. 18 is a schematic diagram illustrating a cutter 1810 secured to a blade 1802. In the illustration depicted in FIG. 18, the blade 1802 is engaged in a cutting operation on a formation 1836. The formation 1836 may include, for example, concrete, asphalt, rock, dirt, and other materials. The cutter 1810 is attached to the blade 1802 at a back rake angle 1834. The cutter 1810 shears the formation 1836 and causes platelets 1838 to curl off and be released from the formation 1836.

The back rake angle 1834 of the cutter 1810 is measured as shown in FIG. 18, wherein a first axis is defined perpendicular to the edge of the blade 1802 at that point. The second axis is defined parallel and along the leading edge of the cutter 1810.

The cutters 110 described herein may be implemented as a plowing cutter. The plowing cutter fails rock using a plowing action that maximizes the rate of penetration in soft to medium-soft formations. The plowing cutter design requires less torque than a standard round cutter. The plowing cutter can yield performance improvements for a microtrenching application by increasing the rate of penetration and decreasing the power requirements to turn the blade.

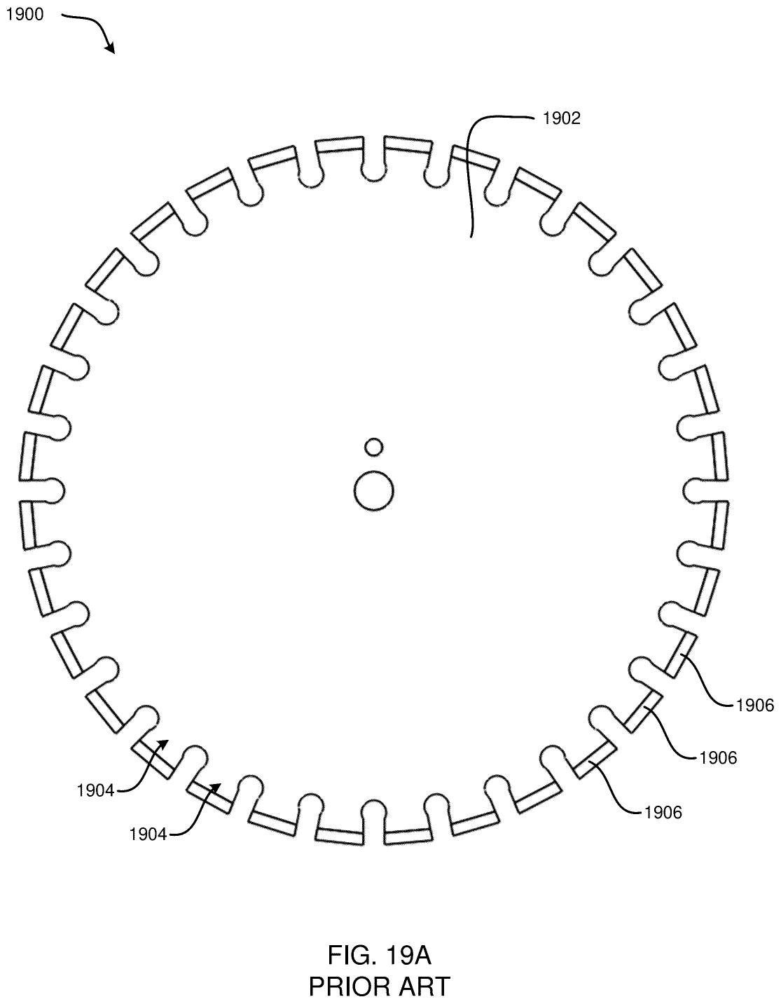

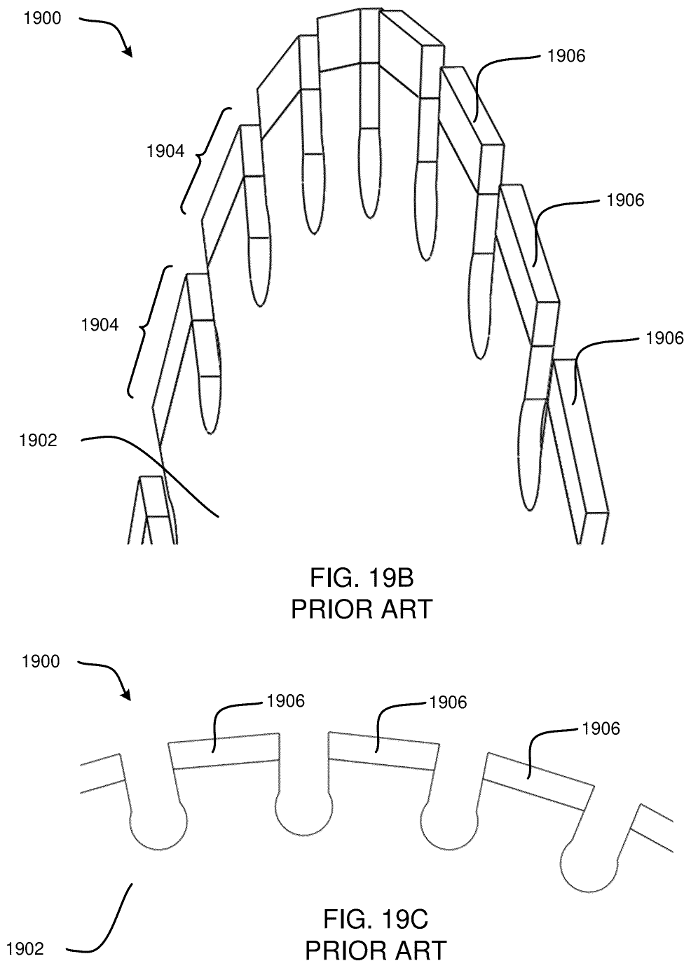

FIGS. 19A-19C illustrate a traditional concrete saw blade that is designed to grind, rather than cut, a substrate like concrete, asphalt, brick, tile, rock, and others. FIG. 19A is a straight-on view of a grinding sawblade 1900, FIG. 19B is a perspective view of a portion of the grinding sawblade 1900, and FIG. 19C is a straight-on close-up view of a portion of the grinding sawblade 1900. The blade 100 and cutting profile 1200 described herein represent improvements over the prior art grinding sawblade 1900 depicted in FIGS. 19A-19C.

The grinding sawblade 1900 includes a blade body 1902 and a plurality of blade segments 1904 extending radially outward relative to the blade body 1902. Each of the plurality of blade segments 1904 includes an abrasive component 1906. As shown in FIGS. 19A-19C, the abrasive components 1906 are the outer-most components of the grinding sawblade 1900 and are thus responsible for grinding the substrate. The abrasive components 1906 include an abrasive material like diamond grit that is suspended or held within a matrix. In some cases, the abrasive components 1906 are manufactured by sintering a matrix comprising one or more metal powders and the diamond grit. In contrast with the improved blade 100 described herein, the grinding sawblade 1900 relies on wearing down the abrasive components 1906 as a function of operation.

The grinding sawblade 1900 is configured to grind a substrate like concrete, asphalt, brick, rock, tile and so forth. When the grinding sawblade 1900 is in use, the abrasive components 1906 come in contact with the substrate. As the grinding sawblade 1900 rotates, the abrasive particles (e.g., diamond grit) on the edge of the abrasive component 1906 grind the substrate. The combination of the abrasive particles and the high rotational speed causes the grinding sawblade 1900 to remove material from the substrate. The abrasive components 1906 continually wear away when the grinding sawblade 1900 is in use. This ensures that new, sharp diamond grit is continuously exposed to grind the substrate. However, this also ensures that the grinding sawblade 1900 wears away quickly and has a relatively short lifespan.

As described herein, the improved blade 100 comprises a plurality of cutters 110 manufactured of a hard material like polycrystalline diamond carbide (PDC). In contrast with the abrasive components 1906 of the grinding sawblade 1900, the cutters 110 of the blade 100 do not require wear as a function of operation. The opposite is true, and the cutters 110 described herein are designed to not wear while cutting the substrate. That is, any wear experienced by the cutters 110 is incidental to the task being accomplished (i.e., cutting the substrate), and is not a result of material purposefully failing over time to reveal new abrasive particles. Thus, in contrast with the grinding sawblade 1900 of the prior art, the cutters 110 are not required to wear for the blade 100 to be capable of cutting the substrate. Additionally, the wear on the hard material of the cutters 110 described herein is orders of magnitude slower than the wear on a diamond grid abrasive component 1906 in the prior art.

Because the grinding sawblade 1900 relies on continuously exposing new, sharp diamond grit to grind the substrate, it is referred to as a “grinding” sawblade rather than a cutting blade. By contrast, the blade 100 described herein is configured to primarily cut or fail the substrate using a shearing action rather than grinding the substrate as is done when using abrasive components in traditional concrete saw blades. The cutters 110 described herein are not purposefully designed to wear down during operation. The blade 100 is proven to fail the substrate significantly faster than the traditional grinding sawblade 1900 known in the art. Additionally, the blade 100 is proven to last for many more uses than the traditional grinding sawblade 1900, and in some cases, the blade 100 will last from 10 to 15 times as long as the traditional grinding sawblade 1900.

FIG. 20 is a primary straight-on view of a side of a blade 2000. The blade 2000 includes the same features as discussed in connection with the blade 100 first illustrated in FIG. 1. However, the blade 2000 includes cutter pockets 20008 configured to receive a cutter 2010 comprising an elliptical cross-sectional geometry, rather than the “pie slice” or circular sector cross-sectional geometry of the cutters 110 first illustrated in FIG. 1. All disclosures provided in connection with the blade 100 first illustrated in FIG. 1 shall similarly apply to the blade 2000 first illustrated in FIG. 20, but with the modification in cutter geometry as described herein.

The blade 2000 includes a blade body 2002, which typically includes a flat disc portion as shown in FIG. 20. The blade 2000 includes a cutting edge 2022 extending around the perimeter of the blade 2000. The cutting edge 2022 of the blade 2000 includes the exterior-most portion of the blade body 2002, along with components of cutter pockets 2008 and cutters 2010. The blade 2000 may specifically be designed to cut hard materials such as concrete, asphalt, brick, or rock. The width of the cutting edge 2022 will be optimized depending on the intended use-case. In some cases, the cutting edge 2022 comprises a narrow width for making a narrow cut into a hard substrate, and in these implementations, the blade is manufactured with a blade width from about 1.5 mm to about 10 mm. In other implementations, the cutting edge 2022 comprises a wider width that is desirable in other applications, and the width may specifically be from about 10 mm to about 100 mm.

The blade 2000 includes a plurality of cutting elements 2004. Each cutting element 2004 includes a gullet 2006, a cutter pocket 2008, and a cutter 2010 (not shown in FIG. 20). The blade 2000 additionally includes a center arbor bore 2014. The center arbor bore 2014 is configured to receive a corresponding cylinder on cutting equipment for stabilizing and rotating the blade. In the implementation depicted in FIG. 20, the blade rotates about an axis of rotation that is perpendicular to the center arbor bore 2014 (such that the blade 2000 spins counterclockwise about an axis of rotation that goes into and out of the page in the illustration in FIG. 20).

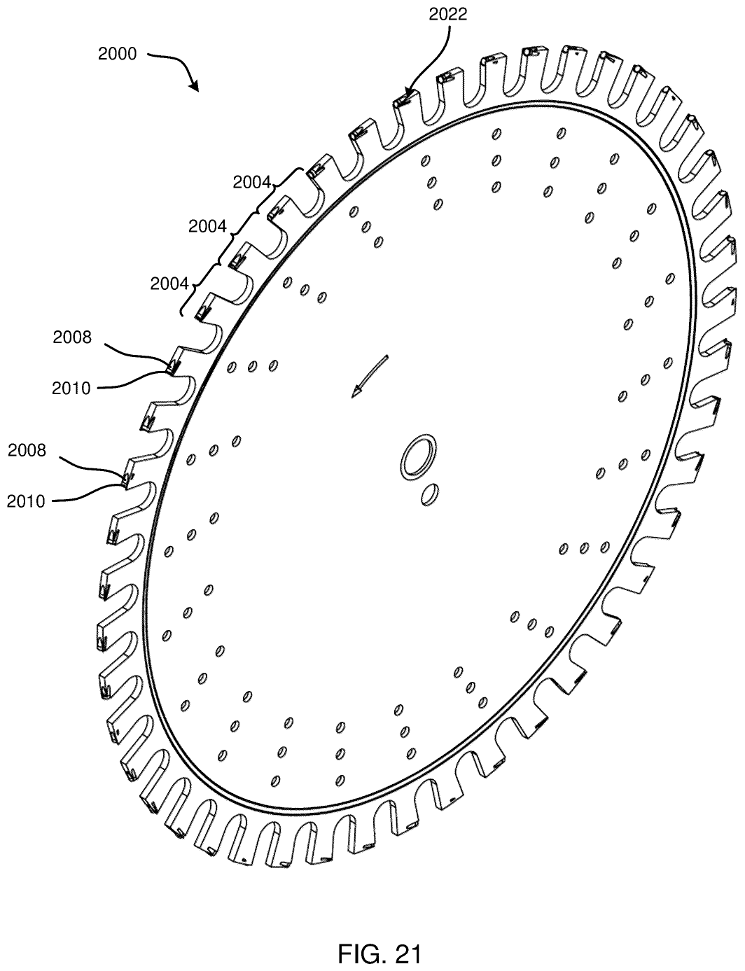

FIG. 21 is a perspective view of the blade 2000 that illustrates a portion of the cutting edge 2022 and width of the blade 2000. Some of the cutters 2010 secured to the cutter pockets 2008 are visible in the perspective view shown in FIG. 21.

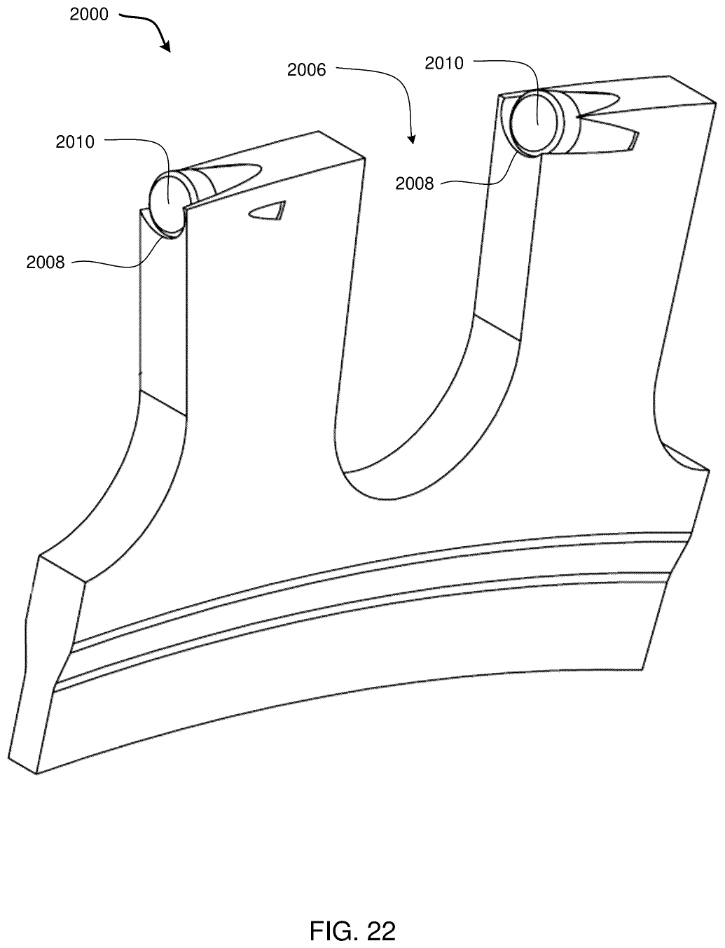

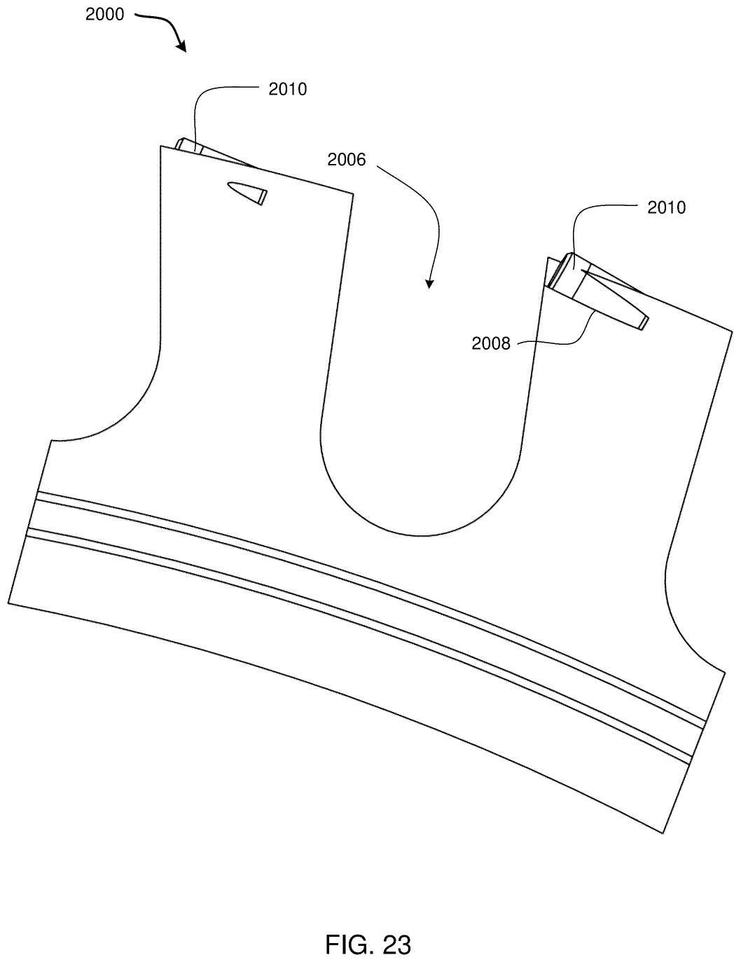

FIG. 22 is a perspective view of a portion of a cutting edge 2022 of the blade 2000. FIG. 23 is a straight-on wide view of a portion of the cutting edge 2022 of the blade 2000. The blade 2000 includes similar features as those discussed in connection with the blade 100 first illustrated in FIG. 1. However, as specifically shown in FIG. 22, the blade 2000 includes cutters 2010 having an elliptical cross-sectional geometry, rather than the “pie slice” circular sector cross-sectional geometry.

The cutter pockets 2008 are designed to accept and securely hold a cutter. The cutter 2010 may be permanently welded or brazed into the cutter pocket 2008, and then the cutter pocket 2008 (with the cuter 2010 affixed therein) is welded or brazed to the blade body 2002. The cutter pockets 2008 are constructed of a hard material such as carbide.

The cutters 2010 described herein are sufficiently hard and durable for cutting hard substrates such as concrete, asphalt, brick, or rock. The hardness and durability of the cutter 2010 is optimized and selected based on manufacturing cost and intended application. The cutters 2010 described herein may be constructed of, for example, polycrystalline diamond compact (PDC), tungsten carbide, silicon carbide, cemented carbide, steel, titanium carbide, tungsten, boron carbide, diamond, and so forth. The cutters may be constructed of a material comprising a hardness equal to or exceeding the hardness of polycrystalline diamond compact (PDC).

The cutters 2010 may specifically be constructed of a super hard material with a hardness value exceeding 40 gigapascals when measured by the Vickers hardness test. The cutters 2010 may be constructed of a material with a hardness value from about 60-150 gigapascals when measured by the Vickers hardness test. The Vickers hardness test was developed by Robert L. Smith and George E. Sandland to measure the hardness of materials. The Vickers hardness test measures the material's ability to resist plastic deformation from a standard source. The unit of hardness given by the test is known as the Vickers Pyramid Number (HV) or Diamond Pyramid Hardness (DPH) and can be converted to SI units (gigapascals). The cutters 2010 may be constructed of a material with a hardness of at least 7 on the Mohs hardness scale and may specifically be constructed of a material with a hardness of at least 8.5 on the Mohs hardness scale.

The cutters 2010 are manufactured independently of the blade body 2002 and the cutter pockets 2008. In some implementations, each cutter 2010 is permanently affixed to a cutter pocket 2008, and then the cutter pocket 2008 is affixed to the blade body 2002. Typically, the cutters 2010 are brazed to the cutter pockets 2008 such that the cutters 2010 are not easily removable. However, it should be understood that the cutters 2010 could be removed by melting the braze with heat. In the case of a large diameter blade, it might be beneficial to remove the cutters 2010 due to wear and then replace the removed cutters 2010 with new cutters 2010. This can easily be done with any of these blades.

The cutters 2010 are arranged such that each cutter performs a portion of the work when cutting rock, concrete, asphalt, brick, or other hard substrate materials. The cutters 2010 may specifically be referred to as “shearing cutters” because they are configured to shear off small pieces of material when the blade 2000 is in use. The progressive cutter layout described herein ensures that each cutter 2010 takes a small “bite” into the substrate such that the workload is distributed across a plurality of cutters 2010 that each occupy a different space within the overall progressive layout. This improves the cutting efficiency and longevity of the blade.

The dimensions of the cutters 2010 are optimized based on the type of material that will be sheared and excavated during the cutting operation. Typically, the desired width of the substrate cut (i.e., the width of the cut made into the substrate) will guide the maximum width of the cutters 2010. In some cases, it is desirable to make a narrow substrate cut, and in these cases, the maximum width of the cutters 2010 may be from about 1.5 mm to about 10 mm.

The cutters are orientated with a back rake angle (the back rake angle is illustrated in FIG. 18). Two or more of the cutters 2010 may have a different back rake angle. In an embodiment, the back rake angles of the cutters 2010 vary within a defined range that is optimized based on the type of material that is being sheared and excavated. In an embodiment, the back rake angles of the cutters 2010 range from 0 degrees to 20 degrees and may specifically range from 5 degrees to 15 degrees. The blade 2000 may include one, two, three, or more different back rake angles across the plurality of cutters 2010 disposed within the blade. The blade 100 is more efficient and demonstrates greater durability when the cutters 110 are installed with varying back rake angles to equally distribute the work of shearing material during the microtrenching operation.

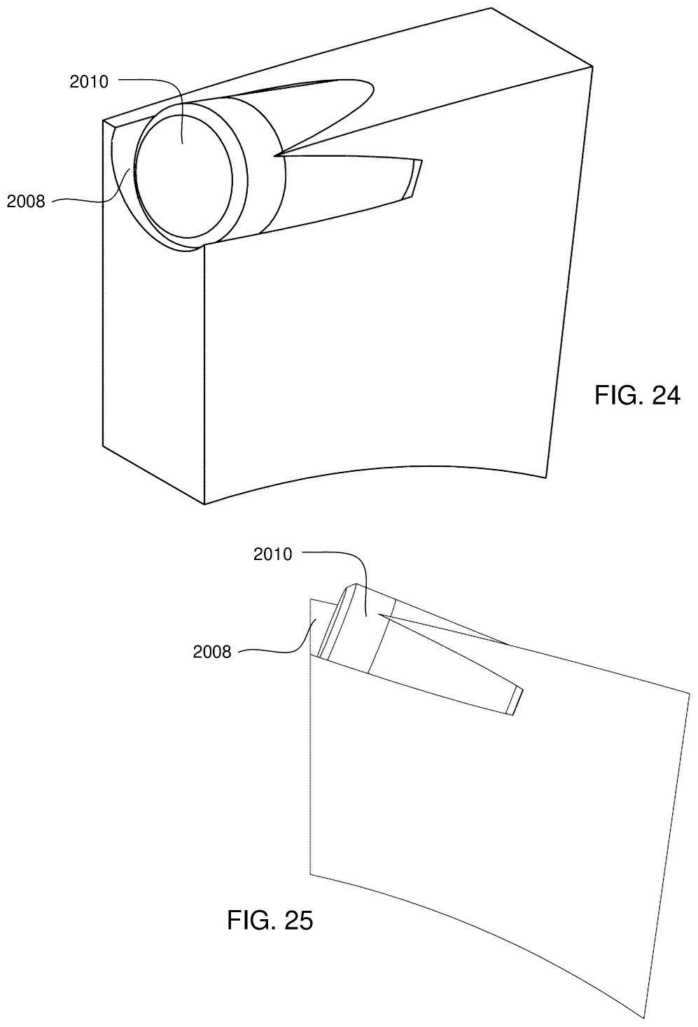

FIGS. 24 and 25 illustrate close-up views of the cutter 2010 disposed within the cutter pocket 2008 of the blade 2000. FIG. 24 illustrate a perspective view of the cutter 2010 disposed within the cutter pocket 2008, and FIG. 25 illustrates a straight-on wide view of the cutter 2010 disposed within the cutter pocket 2008.

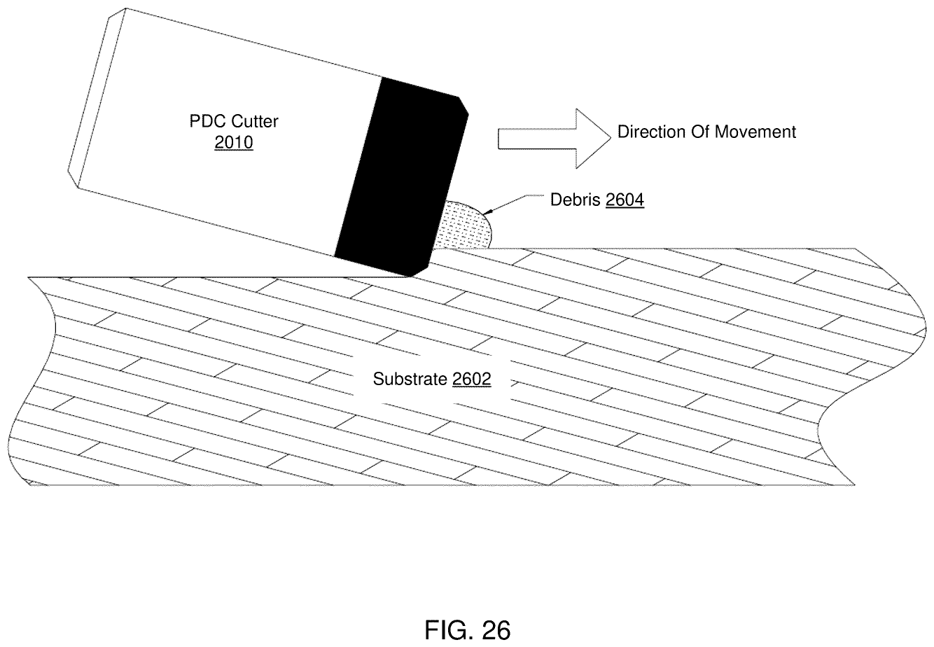

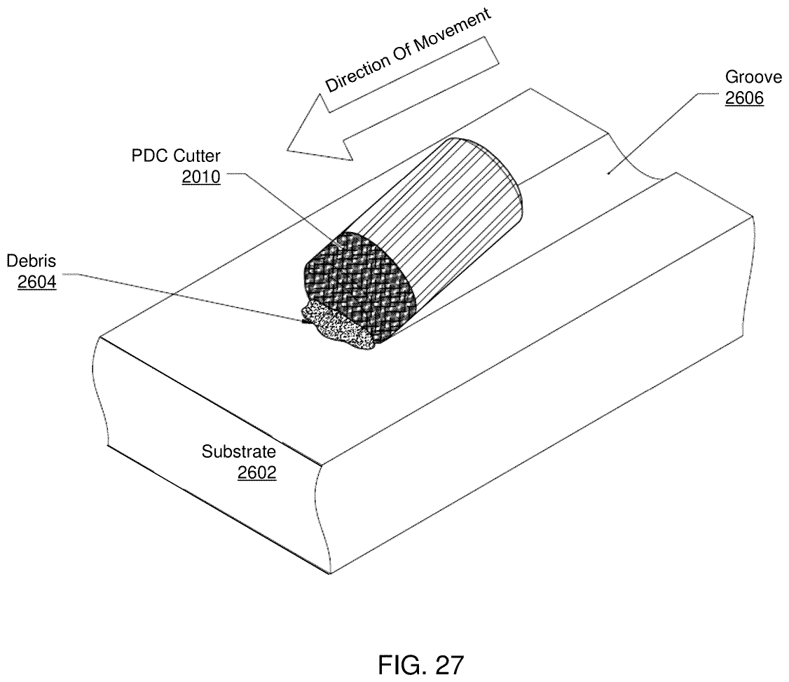

FIGS. 26 and 27 are schematic illustrations of a cutter 2010 as described herein failing a substrate 2602. As shown in FIGS. 26-27, when the cutter 2010 cuts the substrate 2602, a debris 2604 will gather and a groove 2606 will form in the substrate 2602. The dimensions of the groove 2606 will correspond with the dimensions of the cutter 2010.

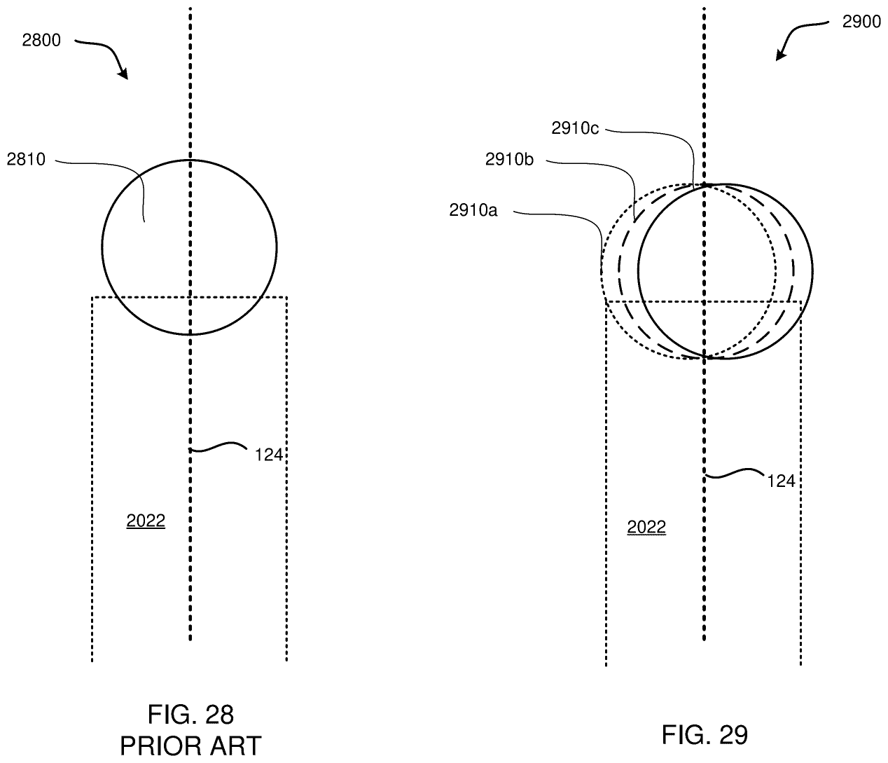

FIG. 28 is a schematic illustration of a cutting profile 2800 for a concrete blade. The cutting profile illustrates the cutting orientation 2810 of the cutters relative to the cutting edge 2022 of the blade. In the configuration illustrated in FIG. 28, all cutters have the same cutting orientation 2810 relative to the centerline 124 of the cutting edge 2022.

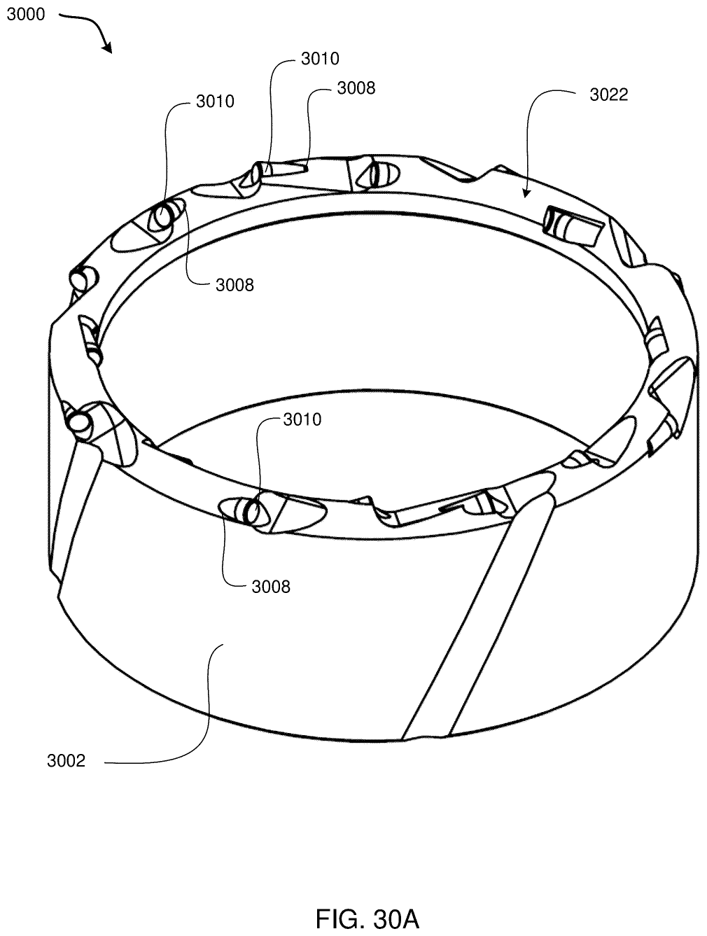

FIG. 29 is a schematic diagram of a progressive cutting profile 2900 for a blade 2000 as described herein. The example cutting profile depicted in FIG. 29 includes three different cutting orientations 2910a, 2910b, 2910c, although a blade may have more cutting orientations. The cutting orientations 2910a-2910c illustrated in FIG. 29 represent the angles of attack and offset locations of the cutters 2010 along the cutting edge 2022 of the blade 2000. In the implementation illustrated in FIG. 29, the cutters 2010 are arranged with three different cutting orientations 2910a-2910c to distribute work across the cutters 2010 and dramatically increase the longevity and durability of the cutters 2010. The quantity of cutting orientations 2910a-2910c distributed around the blade 2000 will be optimized depending on a number of factors, including the intended use of the blade the dimensions of the blade and the cutters.

The cutting profiles 2910a-2910c illustrate where the material (such as rock, concrete, dirt, asphalt, and so forth) is attacked and sheared during operation. The varying cutting profiles 2910a-2910c enable the blade 2000 to cut the substrate material at different locations during operation. The varying cutting profiles 2910a-2910c further ensure the cutters 2010 each perform a small portion of the work during operation. The offset cutter orientations described herein increase the effectiveness and durability of the blade 2000.

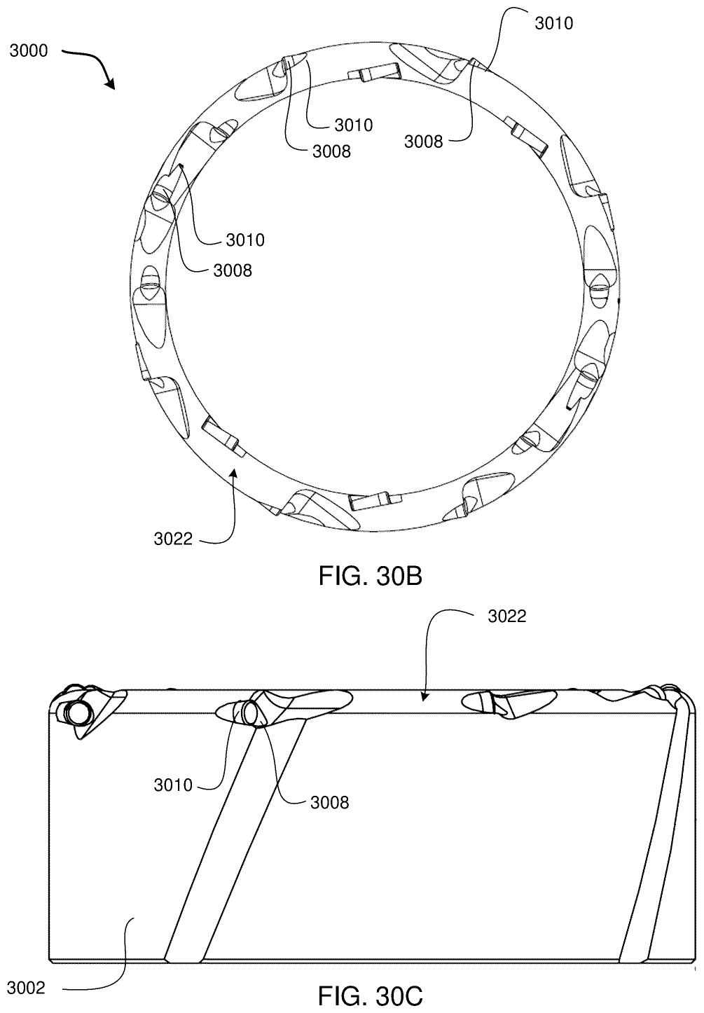

FIGS. 30A-30C, 31, 32A-32B, and 33 illustrate wherein components of the blades described herein are implemented in a core barrel blade configuration. Core barrels are typically utilized in construction related applications and are equipped with a substantially cylindrical geometry with a hollow interior. In some implementations, the hollow interior retains the substrate core when drilling into the substrate. In many cases, the drilled core may be discarded because the removed material is of no use. However, in some instances, the resulting core (i.e., the extracted substrate disposed within the hollow interior of the core barrel) is returned to the hole that has been cut, and the core may be cemented or otherwise affixed back into place.

Core barrels may be utilized in a variety of applications. Some core barrels are optimized for use in construction to cut through a hard substrate such as concrete, steel, reinforced concrete, asphalt, and so forth. The construction-based core barrels are typically equipped with sintered diamond segments that grind through the substrate. In other implementations, core barrels may be utilized for geological drilling. These core barrels are sometimes equipped with polycrystalline diamond cutters and are optimized for a different type of substrate extraction.

The improved core barrels described herein, such as those illustrated in FIGS. 30A-30C, 31, 32A-32B, and 33, are optimized for use in a construction-based application. The core barrels described herein may be equipped with any of the blade components described in connection with the circular saw blades described herein, including any of those components discussed in connection with FIGS. 1-29. The core barrels described herein may include polycrystalline diamond cutters arranged in a progressive cutter layout around a cutting edge of the core barrel. This provides improved longevity for the core barrel when the core barrel is utilized to cut through construction substrates such as concrete, steel, reinforced concrete, asphalt, and so forth.

FIGS. 30A-30C illustrate various views of a core barrel 3000. FIG. 30A illustrates a perspective view of the core barrel 3000, FIG. 30B illustrates an aerial top-down view of the core barrel 3000, and FIG. 30C illustrates a straight-on side view of the core barrel 3000. The core barrel 3000 may include any of the blade components described herein, including any of the components, features, and functions of the circular blade embodiments described in connection with FIGS. 1-29.

The core barrel 3000 includes a blade body 3002, which includes a substantially hollow cylindrical geometry. The core barrel 3000 includes a cutting edge 3022 extending around one edge of the hollow cylindrical geometry of the blade body 3002. The cutting edge 3022 of the core barrel 3000 includes the exterior-most portions of the blade body 3002 at one edge of the hollow cylindrical geometry. The core barrel 3000 may specifically be designed to cut hard materials such as concrete, asphalt, brick, or rock. The width of the cutting edge 3022 will be optimized depending on the intended use-case. In some cases, the cutting edge 3022 comprises a narrow width for making a narrow cut into a hard substrate, and in these implementations, the blade is manufactured with a blade width from about 1.5 mm to about 10 mm. In other implementations, the cutting edge 3022 comprises a wider width that is desirable in other applications, and the width may specifically be from about 10 mm to about 100 mm.

The core barrel 3000 includes a plurality of cutter pockets 3008 and a plurality of cutters 3010. The core barrel 3000 may additionally include other elements of the blades described herein. Like other blades described herein, the cutters 3010 and/or the cutter pockets 3008 may be manufactured independently of the blade body 3002 and then welded, brazed, or otherwise affixed to the blade body 3002. In some implementations, the blade body 3002 and the plurality of cutter pockets 3008 are manufactured together as a single indivisible element constructed of the same material. In these implementations, the blade body 3002 and the plurality of cutter pockets 3008 may each be manufactured of one or more of carbon steel, stainless steel, tool steel, alloy steel, cobalt, or titanium alloy. In an embodiment, the width of the cutting edge 3022 is greater than a thickness of the blade body 3002 of the core barrel 3000.

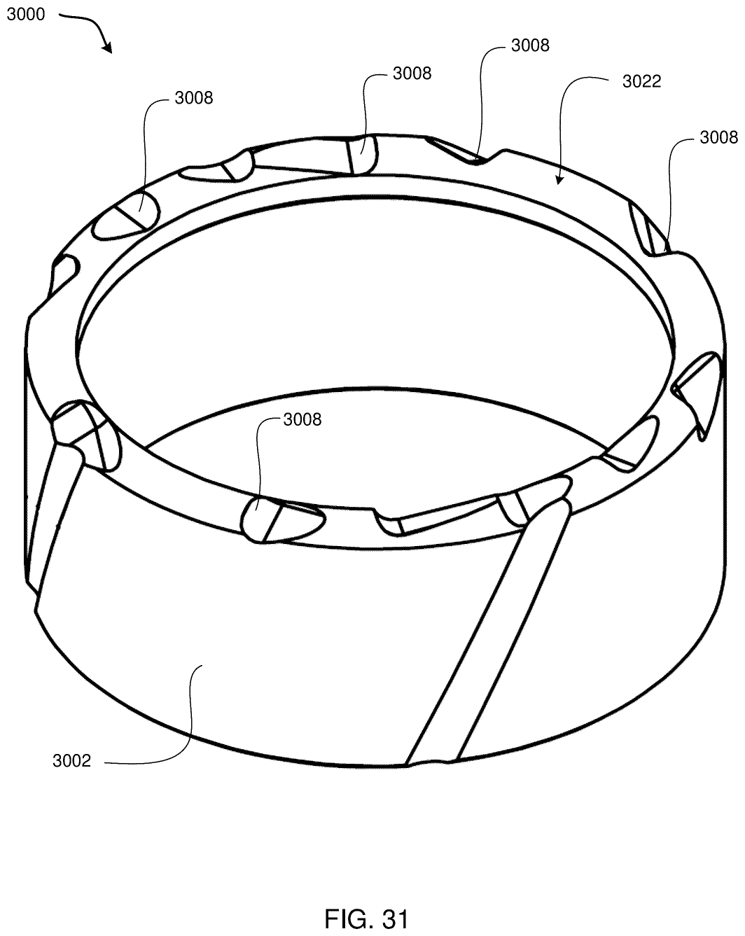

FIG. 31 is a perspective view of the core barrel 3000 first illustrated in FIG. 30A, with the cutters (see 3010) removed. As shown in FIG. 31, the cutter pockets 3008 are oriented according to a progressive cutter layout across the width of the cutting edge 3022. The cutter pockets 3008 may specifically located at different positions across the width of the cutting edge 3022 according to the progressive cutter layout described in FIG. 12 or FIG. 29.

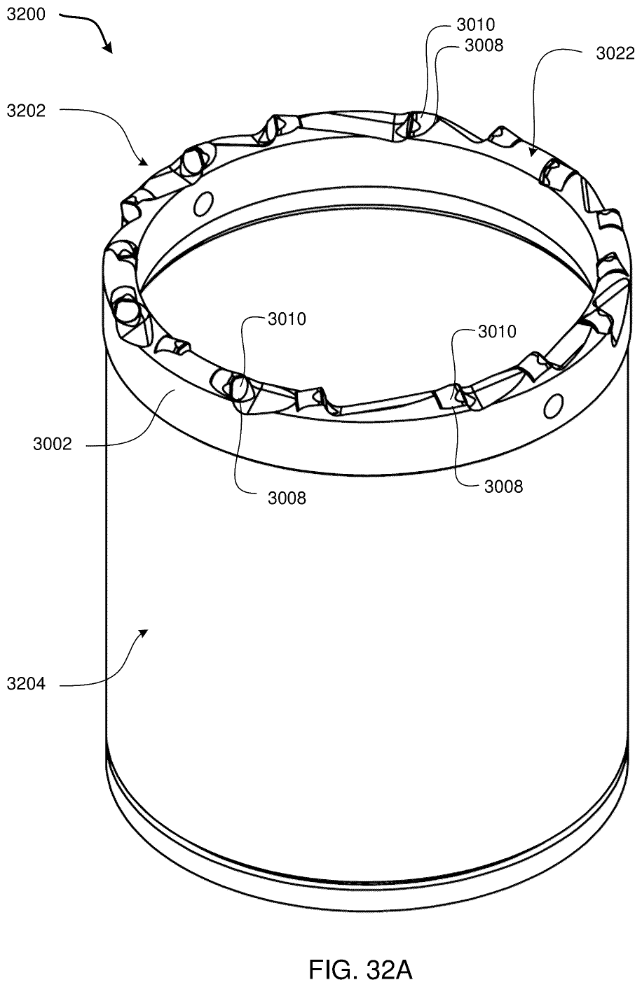

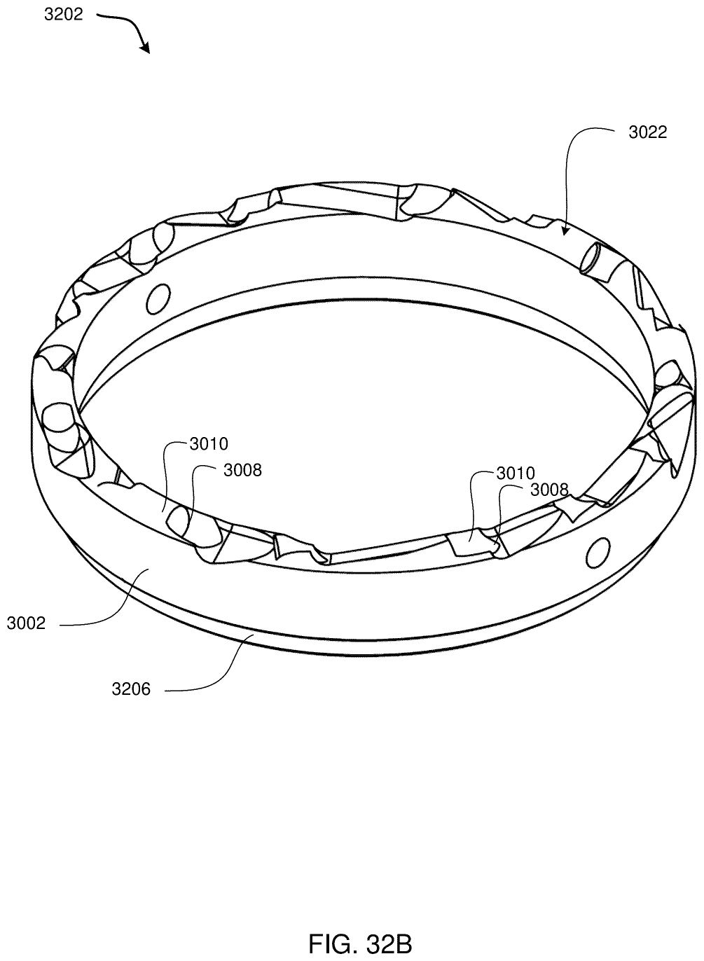

FIGS. 32A and 32B are perspective view of a core barrel 3200 wherein a blade portion 3202 of the core barrel 3200 is separable from a cylindrical body 3204 portion of the core barrel 3200. FIG. 32A illustrates wherein the blade portion 3202 of the core barrel 3200 is attached to the cylindrical body 3204 portion. FIG. 32B illustrates a perspective view of the blade portion 3202 alone. As shown in FIG. 32B, the blade portion 3202 may be equipped with a coupling component 3206 for attaching the blade portion 3202 to the cylindrical body 3204 portion. The coupling component 3206 may include threading for screwing the blade portion 3202 into corresponding threads on the cylindrical body 3204 portion.

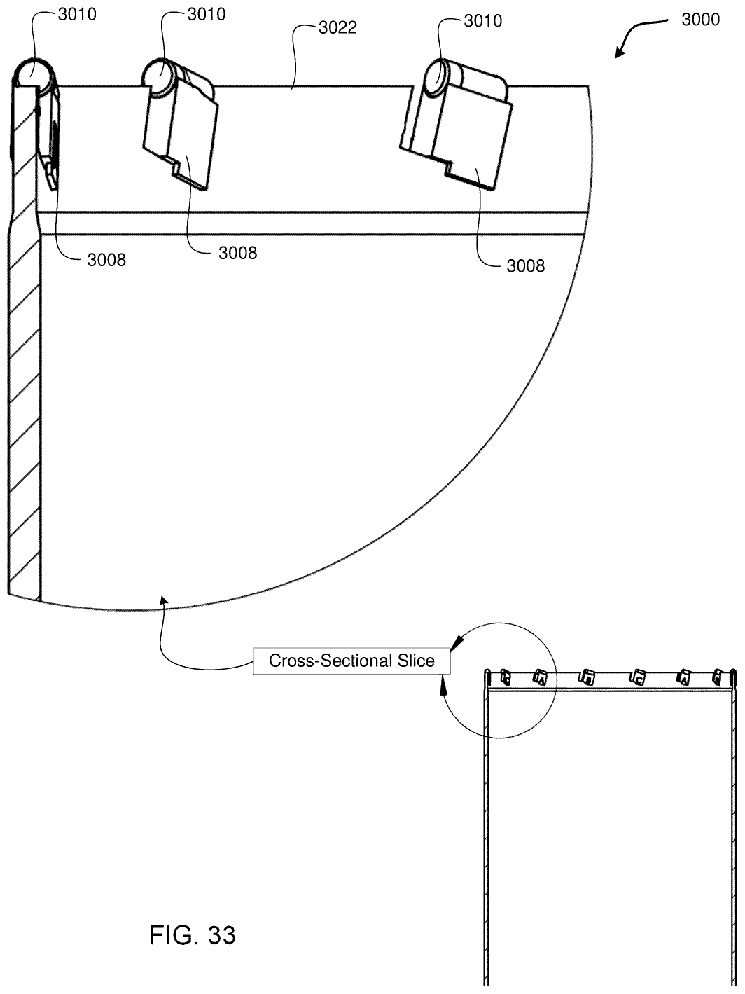

FIG. 33 is a cross-sectional straight-on side view of a portion of a core barrel 3000. FIG. 33 illustrates where the cross-sectional slice and zoomed-in view is taken from the core barrel 3000. FIG. 33 illustrates the cutter pockets 3008 disposed within the cutting edge 3022 of the core barrel 3000. FIG. 33 further illustrates that the cutter pockets 3008 and cutters 3010 may have different orientations relative to each other and relative to the cutting edge 3022. This is one means for implementing a progressive cutter layout to improve the longevity of the cutters 3008 and the core barrel 3000.

### Examples

The following examples pertain to further embodiments.

Example 1 is a blade. The blade includes a blade body. The blade includes a cutter pocket configured to receive a cutter, wherein the cutter pocket is attached to the blade body. The blade includes a cutter attached to the cutter pocket.

Example 2 is a blade as in Example 1, wherein the blade body is manufactured independently of the cutter pocket and the cutter; wherein the cutter is attached to the cutter pocket by way of one or more of welding or brazing; and wherein the cutter pocket is attached to a cutting edge of the blade by way of one or more of welding or brazing.

Example 3 is a blade as in any of Examples 1-2, wherein the blade is optimized for cutting one or more of concrete, rock, brick, or asphalt.

Example 4 is a blade as in any of Examples 1-3, wherein the blade body is manufactured of one or more of carbon steel, stainless steel, tool steel, alloy steel, cobalt, or titanium alloy.

Example 5 is a blade as in any of Examples 1-4, wherein the cutter pocket is manufactured of polycrystalline diamond compact (PDC).

Example 6 is a blade as in any of Examples 1-5, wherein the cutter is manufactured of one or more of carbide, diamond, or polycrystalline diamond compact (PDC).

Example 7 is a blade as in any of Examples 1-6, further comprising a plurality of gullets cut into the blade body, wherein each of the plurality of gullets comprises an opening disposed at a perimeter of the blade body, and wherein the blade comprises a 1:1 ratio of a quantity of gullets to a quantity of cutters.

Example 8 is a blade as in any of Examples 1-7, wherein the blade body comprises a circular cross-sectional geometry.

Example 9 is a blade as in any of Examples 1-8, wherein the blade is a core barrel comprising a hollow cylindrical geometry, and wherein the cutter pocket is attached to the blade body at a cutting edge defined by a circular end of the hollow cylindrical geometry.

Example 10 is a blade as in any of Examples 1-9, wherein the blade body comprises a cutting edge disposed around a perimeter of the blade body; wherein the cutting edge comprises a centerline and a width; and wherein the cutter pocket comprises a plurality of cutter pockets attached to the blade body at different positions relative to the centerline of the cutting edge.

Example 11 is a blade as in any of Examples 1-10, wherein the blade body comprises a cutting edge disposed around a perimeter of the blade body; wherein the cutting edge comprises a centerline and a width; and wherein the cutter comprises a plurality of cutters each attached to one of a plurality of cutter pockets; and wherein each of the plurality of cutter pockets is attached to the blade body on the cutting edge.

Example 12 is a blade as in any of Examples 1-11, wherein two or more of the plurality of cutters are oriented with different cutting orientations relative to the centerline of the cutting edge.

Example 13 is a blade as in any of Examples 1-12, wherein the cutter comprises a circular sector cross-sectional geometry that comprises two radii and an arc; and wherein the corresponding cutter pocket is configured to receive the cutter such that the arc is distal to a center of the blade body relative to the two radii.

Example 14 is a blade as in any of Examples 1-13, wherein the cutter comprises a three-sided cross-sectional geometry.

Example 15 is a blade as in any of Examples 1-14, wherein the cutter pocket comprises an irregular pentagonal cross-sectional geometry.

Example 16 is a blade as in any of Examples 1-15, wherein the cutter pocket comprises an irregular hexagonal cross-sectional geometry.

Example 17 is a blade as in any of Examples 1-16, wherein the cutter is machined from a cylindrical cutter using an electrical discharge machining (EDM) manufacturing technique.

Example 18 is a blade as in any of Examples 1-17, wherein the cylindrical cutter comprises a circular cross-sectional geometry; and wherein the cylindrical cutter is machined to generate four or more of the cutter each comprising a three-sided cross-sectional geometry.

Example 19 is a blade as in any of Examples 1-18, wherein the cutter pocket comprises a plurality of cutter pockets each affixed to a cutting edge defined by a perimeter of the blade body; wherein each of the plurality of cutter pockets comprises a cross-sectional geometry configured to receive a corresponding cutter; and wherein two or more of the cutter pockets comprises a different cross-sectional geometry such that the two or more of the cutter pockets cause the corresponding two or more cutters to be oriented with different cutting orientations relative to a centerline of the cutting edge.

Example 20 is a blade as in any of Examples 1-19, wherein the cutter comprises a plurality of cutters each comprising an identical maximum cutter width within a margin of error; and wherein a substrate cutting width of the blade is greater than the maximum cutter width of the plurality of cutters due to the different cutting orientations relative to the centerline of the cutting edge.

Example 21 is a blade as in any of Examples 1-20, wherein the substrate cutting width is width of a cut made by the blade into a substrate, wherein the substrate comprises one or more of concrete, asphalt, brick, or rock.

Example 22 is a blade as in any of Examples 1-21, wherein the blade exhibits 40 times the durability associated with a blade comprising diamond grit cutters.

Example 23 is a blade as in any of Examples 1-22, wherein the blade exhibits three to five times the cutting speed associated with a blade comprising diamond grit cutters.

Example 24 is a blade as in any of Examples 1-23, wherein the substrate cutting width of the blade is from about 1.5 mm to about 10 mm.

Example 25 is a blade as in any of Examples 1-24, wherein a maximum cutting width of the blade is from about 1.5 mm to about 10 mm.

Example 26 is a blade as in any of Examples 1-25, wherein the cutter is manufactured using an electrical discharge machining (EDM) technique to cut a circular PDC cutter into six or eight equivalent cutters each comprising a circular sector cross-sectional geometry.

Example 27 is a blade as in any of Examples 1-26, wherein the cutter comprises a plurality of cutters arranged in a progressive cutter layout.

Example 28 is a blade as in any of Examples 1-27, wherein the progressive cutter layout is optimized to separate a workload of the blade across the plurality of cutters.

Example 29 is a blade as in any of Examples 1-28, wherein the progressive cutter layout is optimized based on a desired substrate cutting width for the blade.

Example 30 is a method. The method includes cutting a concrete substrate with a blade such as that described in any of Examples 1-29.

Example 31 is a method. The method includes cutting an asphalt substrate with a blade such as that described in any of Examples 1-29.

Example 32 is a method. The method includes cutting a brick substrate with a blade such as that described in any of Examples 1-29.

Example 33 is a blade configured to cut a substrate. The blade includes a blade body and a cutting edge disposed around a perimeter of the blade body, wherein the cutting edge comprises a centerline and a width. The blade includes a plurality of cutter pockets attached to the blade body. The blade is such that two or more of the plurality of cutter pockets are attached to the blade body at a different position along the width of the cutting edge relative to the centerline of the cutting edge.

Example 34 is a blade as in Example 33, wherein the substrate is one or more of concrete, asphalt, brick, rock, or tile.

Example 35 is a blade as in any of Examples 33-34, further comprising a plurality of cutters, wherein each of the plurality of cutters is attached to one of the plurality of cutter pockets.

Example 36 is a blade as in any of Examples 33-35, wherein the blade cuts the substrate by failing the substrate with the plurality of cutters.

Example 37 is a blade as in any of Examples 33-36, wherein the blade body is manufactured independently of the plurality of cutter pockets and the plurality of cutters; wherein each of the plurality of cutters is attached to the one of the plurality of cutter pockets by way of one or more of welding or brazing; and wherein the plurality of cutter pockets are attached to the cutting edge of the blade body by way of one or more of welding or brazing.

Example 38 is a blade as in any of Examples 33-37, wherein the blade body and the plurality of cutter pockets are manufactured together as a single indivisible element; wherein the plurality of cutters are manufactured independently of the single indivisible element comprising the blade body and the plurality of cutter pockets; and wherein each of the plurality of cutters is attached to the one of the plurality of cutter pockets by way of one or more of welding or brazing.

Example 39 is a blade as in any of Examples 33-38, wherein each of the plurality of cutters comprises an identical maximum cutter width within a margin of error.

Example 40 is a blade as in any of Examples 33-39, wherein a substrate cutting width of the blade is greater than the maximum cutter width of the plurality of cutters.

Example 41 is a blade as in any of Examples 33-40, wherein the blade body is manufactured of one or more of carbon steel, stainless steel, tool steel, alloy steel, cobalt, or titanium alloy.

Example 42 is a blade as in any of Examples 33-41, wherein the plurality of cutter pockets are manufactured of one or more of carbide or polycrystalline diamond compact (PDC).

Example 43 is a blade as in any of Examples 33-42, wherein the blade body and the plurality of cutter pockets are manufactured together as a single indivisible element, and wherein the single indivisible element comprising the blade body and the plurality of cutter pockets is manufactured of one or more of carbon steel, stainless steel, tool steel, alloy steel, cobalt, or titanium alloy.

Example 44 is a blade as in any of Examples 33-43, wherein the plurality of cutters are manufactured of one or more of carbide, diamond, or polycrystalline diamond compact (PDC).

Example 45 is a blade as in any of Examples 33-44, wherein the plurality of cutters do not comprise diamond grit such that the plurality of cutters is configured to cut the substrate rather than grind the substrate.

Example 46 is a blade as in any of Examples 33-45, wherein the two or more of the plurality of cutters are oriented with different cutting orientations relative to the centerline of the cutting edge.

Example 47 is a blade as in any of Examples 33-46, wherein at least a portion of the plurality of cutters comprises a circular sector cross-sectional geometry that comprises two radii and an arc.

Example 48 is a blade as in any of Examples 33-47, wherein at least a portion of the plurality of cutters comprises a three-sided cross-sectional geometry.

Example 49 is a blade as in any of Examples 33-48, wherein at least a portion of the plurality of cutter pockets comprises an irregular pentagonal cross-sectional geometry or an irregular hexagonal cross-sectional geometry.

Example 50 is a blade as in any of Examples 33-49, wherein at least a portion of the plurality of cutters is machined from a cylindrical cutter using an electrical discharge machining (EDM) manufacturing technique.

Example 51 is a blade as in any of Examples 33-50, wherein each of the plurality of cutter pockets comprises a cross-sectional geometry configured to receive a corresponding cutter; and wherein a first cutter pocket of the plurality of cutter pockets comprises a different cross-sectional geometry than a second cutter pocket of the plurality of cutter pockets.

Example 52 is a blade as in any of Examples 33-51, wherein the first cutter pocket is configured to receive a first cutter that cuts the substrate at a first cutting orientation; wherein the second cutter pocket is configured to receive a second cutter that cuts the substrate at a second cutting orientation; and wherein the first cutting orientation is different than the second cutting orientation relative to the centerline of the cutting edge of the blade body.

Example 53 is a blade as in any of Examples 1-52, wherein the cutter comprises an elliptical cross-sectional geometry.

Example 54 is a blade as in any of Examples 1-53, wherein the cutter comprises a circular cross-sectional geometry.

Example 55 is a blade as in any of Examples 1-54, wherein the blade comprises a plurality of cutters arranged in a progressive cutter layout relative to a centerline of the cutting edge of the blade.

Example 56 is a blade as in any of Examples 1-55, wherein the blade is a circular blade such that the blade body comprises a substantially circular geometry; and wherein the cutting edge is disposed around the perimeter of the substantially circular geometry of the blade body.

Example 57 is a blade as in any of Examples 1-56, wherein the blade is a core barrel such that the blade body comprises a substantially cylindrical geometry comprising a hollow interior; and wherein the cutting edge is disposed around the perimeter of the substantially cylindrical geometry at one end of the substantially cylindrical geometry.

Example 58 is a method. The method includes cutting a substrate using any of the blades described in Examples 1-29 and 33-57.

Example 59 is a method as in Example 58, wherein the substrate is concrete.

Example 60 is a method as in any of Examples 58-59, wherein the substrate is brick.

Example 61 is a method as in any of Examples 58-60, wherein the substrate is asphalt.

Example 62 is a method as in any of Examples 58-61, wherein the substrate is rock.

Example 63 is a method as in any of Examples 58-62, wherein the substrate is tile.

Example 64 is a method as in any of Examples 58-63, wherein cutting the substrate comprises primarily failing the substrate rather than grinding the substrate.

Example 65 is a method as in any of Examples 58-64, wherein the blade is designed without abrasive particles embedded into a blade segment such that the blade is not designed to wear away and expose new abrasive particles to grind the substrate.

It is to be understood that any features of the above-described arrangements, examples, and embodiments may be combined in a single embodiment comprising a combination of features taken from any of the disclosed arrangements, examples, and embodiments.

In the foregoing Detailed Description of the Disclosure, various features of the disclosure are grouped together in a single embodiment for the purpose of streamlining the disclosure. This method of disclosure is not to be interpreted as reflecting an intention that the claimed disclosure requires more features than are expressly recited in each claim. Rather, inventive aspects lie in less than all features of a single foregoing disclosed embodiment.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements.

Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

The foregoing description has been presented for the purposes of illustration and description. It is not intended to be exhaustive or to limit the disclosure to the precise form disclosed. Many modifications and variations are possible in light of the above teaching. Further, it should be noted that any or all the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A blade configured to cut a substrate, the blade comprising:
a blade body;
a cutting edge disposed around a perimeter of the blade body, wherein the cutting edge comprises a centerline and a width; and
a plurality of cutter pockets attached to the blade body;
wherein the plurality of cutter pockets is attached to the blade body according to a progressive cutter layout such that two or more of the plurality of cutter pockets are attached to the blade body at a different position across the width of the cutting edge relative to the centerline of the cutting edge.

2. The blade of claim 1, wherein the substrate is one or more of concrete, asphalt, brick, rock, or tile.

3. The blade of claim 1, further comprising a plurality of cutters, wherein each of the plurality of cutters is attached to one of the plurality of cutter pockets.

4. The blade of claim 3, wherein the blade cuts the substrate by failing the substrate with the plurality of cutters.

5. The blade of claim 3, wherein the blade body is manufactured independently of the plurality of cutter pockets and the plurality of cutters;
wherein each of the plurality of cutters is attached to the one of the plurality of cutter pockets by way of one or more of welding or brazing; and
wherein the plurality of cutter pockets are attached to the cutting edge of the blade body by way of one or more of welding or brazing.

6. The blade of claim 3, wherein the blade body and the plurality of cutter pockets are manufactured together as a single indivisible element;
wherein the plurality of cutters are manufactured independently of the single indivisible element comprising the blade body and the plurality of cutter pockets; and
wherein each of the plurality of cutters is attached to the one of the plurality of cutter pockets by way of one or more of welding or brazing.

7. The blade of claim 3, wherein each of the plurality of cutters comprises an identical maximum cutter width within a margin of error.

8. The blade of claim 7, wherein a substrate cutting width of the blade is greater than the maximum cutter width of the plurality of cutters.

9. The blade of claim 1, wherein the blade body is manufactured of one or more of carbon steel, stainless steel, tool steel, alloy steel, cobalt, or titanium alloy.

10. The blade of claim 1, wherein the plurality of cutter pockets are manufactured of one or more of carbide or polycrystalline diamond compact (PDC).

11. The blade of claim 1, wherein the blade body and the plurality of cutter pockets are manufactured together as a single indivisible element, and wherein the single indivisible element comprising the blade body and the plurality of cutter pockets is manufactured of one or more of carbon steel, stainless steel, tool steel, alloy steel, cobalt, or titanium alloy.

12. The blade of claim 3, wherein the plurality of cutters are manufactured of polycrystalline diamond compact (PDC).

13. The blade of claim 3, wherein the plurality of cutters do not comprise cutter segments designed to fail the substrate by grinding, and that the plurality of cutters is configured to cut the substrate rather than grind the substrate.

14. The blade of claim 1, wherein the two or more of the plurality of cutters are oriented with different cutting orientations relative to the centerline of the cutting edge.

15. The blade of claim 3, wherein at least a portion of the plurality of cutters comprises a circular sector cross-sectional geometry that comprises two radii and an arc.

16. The blade of claim 3, wherein at least a portion of the plurality of cutters comprises a three-sided cross-sectional geometry.

17. The blade of claim 1, wherein at least a portion of the plurality of cutter pockets comprises an irregular pentagonal cross-sectional geometry or an irregular hexagonal cross-sectional geometry.

18. The blade of claim 3, wherein at least a portion of the plurality of cutters is machined from a cylindrical cutter using an electrical discharge machining (EDM) manufacturing technique.

19. The blade of claim 1, wherein each of the plurality of cutter pockets comprises a cross-sectional geometry configured to receive a corresponding cutter; and
wherein a first cutter pocket of the plurality of cutter pockets comprises a different cross-sectional geometry than a second cutter pocket of the plurality of cutter pockets.

20. The blade of claim 18, wherein the first cutter pocket is configured to receive a first cutter that cuts the substrate at a first cutting orientation;
wherein the second cutter pocket is configured to receive a second cutter that cuts the substrate at a second cutting orientation; and
wherein the first cutting orientation is different than the second cutting orientation relative to the centerline of the cutting edge of the blade body.

21. The blade of claim 1, wherein the blade is a circular blade such that the blade body comprises a substantially circular geometry; and
wherein the cutting edge is disposed around the perimeter of the substantially circular geometry of the blade body.

22. The blade of claim 1, wherein the blade is a core barrel such that the blade body comprises a substantially cylindrical geometry comprising a hollow interior; and
wherein the cutting edge is disposed around the perimeter of the substantially cylindrical geometry at one end of the substantially cylindrical geometry.
